(19) United States
(12) Patent Application Publication
(10) Pub. No.: US 2003/0194445 A1
(43) Pub. Date: Oct. 16, 2003

(54) Compositions and methods of use of peptides in combination with biocides and/or germicides

(76) Inventors: Carla H. Kuhner, Avondale, PA (US); James A. Romesser, Kennett Square, PA (US)

Correspondence Address: Patrick J. Farley, Ph.D., Woodcock Washburn LLP, One Liberty Place - 46th Floor, Philadelphia, PA, 19103, US

(21) Appl. No.: 10/005,931

(22) Filed: Nov. 12, 2001

(51) Int. Cl. A01N 55/02; A01N 43/80; A01N 43/50; A01N 47/40; A01N 47/46

(52) U.S. Cl. 424/622; 514/17; 514/18; 514/19; 424/661; 514/372; 514/389; 514/184; 514/514; 514/634; 514/642; 514/693; 514/727; 514/730

(57) ABSTRACT

Peptide compositions and methods for inhibiting and controlling the growth of microbes using peptides possessing antimicrobial activity are described. The composition comprises at least one antimicrobial peptide in combination with at least one biocide, germicide, preservative or antibiotic. The method comprises administering an amount of the peptide composition effective for the prevention, inhibition or termination of microbes in industrial and clinical settings.

### BACKGROUND OF THE INVENTION

1. Field of the Invention

This invention relates to peptide compositions comprising peptides having antimicrobial activity and methods of making them and using them with at least one biocide, germicide, preservative and/or antibiotic to combat microbes. Peptides of the present invention are useful in the treatment of industrial systems and pharmaceuticals to treat clinically relevant diseases in mammals, but their application is not limited thereto.

2. Background of the Invention and Related Information

Peptides are now recognized as part of a global defense mechanism used by animals and plants in terrestrial and marine environments to prevent microbial attack. The discovery of antimicrobial peptides has generated interest in the use of these compounds to combat clinically relevant microorganisms, in particular, multi-drug resistant organisms. Large screening programs have been developed to identify potential peptide-based drug candidates from both natural product-and combinatorial chemistry-derived libraries. Antimicrobial peptides are also potential candidates for the prevention of biofouling in industrial water systems, where they would represent a novel chemical class of antibiofouling compounds.

Peptides are produced naturally in bacteria, fungi, plants, insects, amphibians, crustaceans, fish and mammals [Hancock, Advances in Microbial Physiology, 135-175, Academic Press (1995)]. They represent a major inducible defense against microbes and their production in the immune system of many species is controlled by transcriptional elements. For instance, in humans, antimicrobial peptides are found in neutrophils which are responsible for responding against invasion of foreign organisms [Lehrer et al. ASM News, 56, 315-318, (1990)]. Natural antimicrobial peptides have a moderate spectrum of activity against microbes and are usually present in moderate amounts. Natural antimicrobial peptides of 12-50 amino acid residues have been obtained in the past 20 years via isolation from the defense systems of insects, amphibians and mammals [Oh et al. J. Peptide Res., 56, 41-46, (1998)]. Use of these peptides in clinical trials has shown effective antimicrobial activity [Hancock, Exp. Opin. Invest. Drugs, 7, 167-174, (1998)]. Treatment of microorganisms with antibiotics has resulted in inadequate inhibition of bacterial growth due to resistance. Peptides have shown excellent activity against antibiotic resistant microorganisms in vitro [Hancock and Lehrer, TiB Tech., 16, 82-88, (1998)].

The charge distribution and hydrophobic properties of a peptide appear to be important factors in determining its effectiveness. The peptides are usually large (12-50 amino acids) and said to be cationic due to the presence of positively charged basic amino acid residues such as arginine and lysine [Hancock, Exp. Opin. Invest. Drugs, 7, 167-174, (1998)]. It is suggested that the cationicity of the peptide may play an important role in the peptide interaction with negatively charged membranes. For instance, cationic peptides are said to compete with divalent cations on the surface of Gram-negative bacteria and prevent their interaction with lipopolysaccharide (LPS) molecules [Hancock, Exp. Opin. Invest. Drugs, 7, 167-174, (1998)]. It is hypothesized that the displacement of divalent cations by cationic peptides creates a distortion in the outer membrane of the bacteria through which peptides may pass.

Industrial facilities employ many methods of preventing biofouling of industrial water systems. Many microbial organisms are involved in biofilm formation in industrial waters. Growth of slime-producing bacteria in industrial water systems causes problems including decreased heat transfer, fouling and blockage of lines and valves, and corrosion or degradation of surfaces. Control of bacterial growth in the past has been accomplished with biocides. Many biocides and biocide formulations are known in the art. However, many of these contain components which may be environmentally deleterious or toxic, and are often resistant to breakdown.

The manufacturing cost of peptides may be a limiting factor in their antimicrobial application [Hancock and Lehrer, TiB Tech., 16, 82-88, (1998)]. The long chain length of the natural antimicrobial peptides is a major factor contributing to their cost of synthesis.

Many biocides, germicides, preservatives and antibiotics are known in the art. Combination of these compounds with other antimicrobial compounds or with non-antimicrobial compounds that enhance the efficacy of the biocide, germicide, preservative or antibiotic has resulted in compositions with better antimicrobial activity than the biocides, germicides, preservatives or antibiotics alone.

U.S. Pat. No. 5,417,875 describes a detergent composition consisting of an N-acylamino acid salt containing an acyl chain of 10-16 carbon atoms, preferably 12-14 carbon atoms, and a germicide such as triclosan, trichlorocarbanilide, isopropylmethylphenol, and chlorhexidine hydrochloride. The detergent composition is said to exert a good germicidal effect suitable for cleansing the skin.

U.S. Pat. No. 5,607,597 discloses an antimicrobial composition and method said to enhance the control of microbial growth in an aqueous system by addition of an alkylsulfosuccinate surfactant to biocidal compounds.

Another U.S. Pat. No. 5,432,184 discloses antimicrobial compositions consisting of diiodomethyl-p-tolylsulfone and methods of use said to be effective for controlling the growth of fungus, especially Trichoderma viridae. U.S. Pat. No. 5,416,121 utilizes a composition consisting of diiodomethyl-p-tolylsulfone and β-bromo-β-nitrostyrene for treatment of microbes such as Trichoderma viridae in water containing systems.

U.S. Pat. No. 5,416,122 utilizes a combination of diiodomethyl-p-tolylsulfone and bis trichloro methyl for treatment of microbes including Trichoderma viridae. U.S. Pat. No. 5,352,706 discloses a combination of diiodomethyl-p-tolylsulfone and alkyl dimethyl benzyl ammonium chloride said to be effective in the treatment of water containing sytems against microbes including Trichoderma viridae.

Still another, U.S. Pat. No. 5,416,190 discloses a composition consisting of 3-iodo-2-propynyl-butyl carbamate and n-alkyl dimethyl benzyl ammonium chloride said to be effective against microbes such as Trichoderma viridae in water containing systems.

The production of safe, nontoxic peptides with antimicrobial activity has generated interest in the use of these compounds against industrial and clinically relevant microorganisms. The present invention provides combinations of short peptides with biocides, germicides, antibiotics and/or preservatives which provide an effective, nontoxic method of inhibiting microbial growth.

### SUMMARY OF THE INVENTION

The invention provides antimicrobial compositions comprising at least one chemically-modified peptide and a second antimicrobial compound wherein the chemically-modified peptide is represented by Formula I:

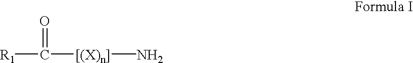

wherein:

X is any natural or non-natural, modified or unmodified amino acid except glutamate or aspartate;

n=1 to 5;

(a) when the chemically-modified peptide is 1-3 amino acids, at least one amino acid is a cationic amino acid, the net charge of the chemically modified peptide at neutral pH is at least +1, and the chemically-modified peptide does not contain glutamate or aspartate;

(b) when the chemically-modified peptide is 4-5 amino acids, at least two of the amino acids are cationic amino acids, the net charge of the chemically-modified peptide at neutral pH is at least +2, and the chemically-modified peptide does not contain glutamate or aspartate;

wherein:

R₁ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₃ is independently hydrogen; C₁-C₄ alkyl; or phenyl optionally substituted with at least one R₈;

R₄ is independently hydrogen; C₁-C₈ alkyl; or phenyl optionally substituted with at least one R₈;

R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;

R₆ is independently methyl; ethyl; methoxy; methylthio; halogen; or trifluoromethyl;

R₇ is independently halogen;

R₈ is independently halogen; C₁-C₄ alkyl; C₁-C₄ alkoxy; C₁-C₄ haloalkyl; nitro; or cyano; and

wherein the second antimicrobial compound is a compound selected from the group consisting of a biocide, a biodispersant, a surfactant, a germicide, a preservative, an antibacterial agent, an antiviral agent, an antifungal agent and an antiparasitic agent.

The invention also provides antimicrobial compositions comprising at least one chemically-modified peptide and a second antimicrobial compound wherein the chemically-modified peptide is represented by Formula II:

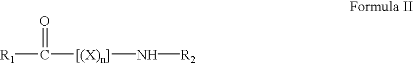

wherein:

X is any natural or non-natural, modified or unmodified amino acid except glutamate or aspartate;

n=1 to 10;

(a) when the chemically-modified peptide is 1-3 amino acids, at least one amino acid is a cationic amino acid, the net charge of the chemically-modified peptide at neutral pH is at least +1, and the chemically-modified peptide does not contain glutamate or aspartate;

(b) when the chemically-modified peptide is 4-5 amino acids, at least two of the amino acids are cationic amino acids, the net charge of the chemically-modified peptide at neutral pH is at least +2, and the chemically-modified peptide does not contain glutamate or aspartate;

(c) when the chemically-modified peptide is 6-8 amino acids, at least three of the amino acids are cationic amino acids, the net charge of the chemically-modified peptide at neutral pH is preferably at least +3, and the chemically-modified peptide does not contain glutamate or aspartate; and

(d) when the chemically-modified peptide is 9-10 amino acids, at least four of the amino acids are cationic amino acids, the net charge of the chemically-modified peptide at neutral pH is preferably at least +4, and the chemically-modified peptide does not contain glutamate or aspartate;

wherein:

R₁ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₃ is independently hydrogen; C₁-C₄ alkyl; or phenyl optionally substituted with at least one R₈;

R₄ is independently hydrogen; C₁-C₈ alkyl; or phenyl optionally substituted with at least one R₈;

R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;

R₆ is independently methyl; ethyl; methoxy; methylthio; halogen; or trifluoromethyl;

R₇ is independently halogen;

R₈ is independently halogen; C₁-C₄ alkyl; C₁-C₄ alkoxy; C₁-C₄ haloalkyl; nitro; or cyano; and

wherein: the second antimicrobial compound is a compound selected from the group consisting of a biocide, a biodispersant, a surfactant, a germicide, a preservative, an antibacterial agent, an antiviral agent, an antifungal agent and an antiparasitic agent.

The antimicrobial compositions include, but are not limited to compositions comprising a chemically-modified peptide comprising 2 amino acids wherein the N-terminal amino acid is a cationic amino acid, and the C-terminal amino acid is any amino acid except glutamate or aspartate.

The antimicrobial composition also include, but are not limited to compositions comprising a chemically-modified peptide selected from the group consisting of Arg-Trp; Lys-Trp; and Orn-Trp.

Furthermore, the antimicrobial compositions of the invention include, but are not limited to compositions comprising a chemically-modified peptide selected from the group consisting of Arg-Phe-Arg; Lys-Phe-Arg; Lys-Phe-Lys; Arg-Phe-Lys; Orn-Phe-Arg; Orn-Phe-Orn; Arg-Phe-Orn; Arg-Trp-Phe; Lys-Trp-Phe; Orn-Trp-Phe; Arg-Trp-Cys; Lys-Trp-Cys; Orn-Trp-Cys; Arg-Phe-Trp; Lys-Phe-Trp; Orn-Phe-Trp; Arg-Arg-Trp; Lys-Lys-Trp; Lys-Arg-Trp; Arg-Lys-Trp; Orn-Orn-Trp; Orn-Arg-Trp; Arg-Orn-Trp; Arg-Trp-Arg; Lys-Trp-Arg; Arg-Trp-Lys; Lys-Trp-Lys; Orn-Trp-Arg; Arg-Trp-Orn; and Orn-Trp-Orn.

Furthermore, the antimicrobial compositions of the invention include, but are not limited to compositions comprising a chemically-modified peptide selected from the group consisting of SEQ ID NO:1; SEQ ID NO:2; SEQ ID NO:3; SEQ ID NO:4; SEQ ID NO:5; SEQ ID NO:6; SEQ ID NO:7; SEQ ID NO:8; SEQ ID NO:9; SEQ ID NO:10; SEQ ID NO:11; SEQ ID NO:12; SEQ ID NO:13; SEQ ID NO:14; SEQ ID NO:15; SEQ ID NO:16; SEQ ID NO:17; SEQ ID NO:18; SEQ ID NO:19; SEQ ID NO:20; SEQ ID NO:21; SEQ ID NO:22; and SEQ ID NO:23.

The antimicrobial compositions of the invention include a second antimicrobial compound, such as a biocide, or surfactant or biodispersant, such as, for example, dodecylguanidine hydrochloride; methylene bis (thiocyanate); n-alkyl dimethylbenzylammonium chloride; glutaraldehyde; 2,2-dibromo-3-nitrilo propionamide; 5-chloro-2-methyl-4-isothiazolin-3-one; 2-methyl-4-isothiazolin-3-one; or 2-bromo-2-nitropropane-1,3-diol; sodium or calcium hypochlorite; sodium bromide; β-bromo-β-nitrostyrene; oxazolidines; chromated copper arsenate; zinc pyrithione; copper pyrithione; a carbamate; a halohydantoin; dinonylsulfosuccinate; sodium lauryl sulfate; and the like.

Biocides or biodispersants are typically present in an amount of about 0.0000002% to about 5% by weight of biocide or biodispersant based on the weight percentage of the total composition. In some embodiments, the biocide or biodispersant is present in an amount of about 0.0000002% to about 1% by weight of biocide or biodispersant based on the weight percentage of the total composition.

The compositions of the invention contain a germicide or preservative as the second antimicrobial compound. Germicides or preservatives include, but are not limited to 2,4,4′ trichloro-2′-hydroxydiphenylether, 1-(4-chlorophenyl)-3-(3,4-dichlorophenyl) urea, isopropylmethylphenol, chlorhexidine hydrochloride, hexamidine diisethionate, octopirox, chloroxylenol, benzoyl peroxide, phenoxy alcohols, and hydroxybenzoic acids, and the like.

The germicide or preservative is typically present in an amount of about 0.0001% to about 10% by weight of germicide or preservative based on the weight percentage of the total composition. In other embodiments, the germicide or preservative is present in an amount of about 0.0001% to about 5% by weight of germicide or preservative based on the weight percentage of the total composition. In other embodiments, the germicide or preservative is present in an amount of about 0.0001% to about 3% by weight of germicide based on the weight percentage of the total composition.

The compositions of the invention may comprise an antibiotic as the second antimicrobial compound. Antibiotics include, but are not limited to penicillin, cephalosporin, carbapenem, β-lactamase inhibitor, aminoglycoside, aminocyclitol, quinolone, macrolide, tetracycline, glycopeptide, lipopeptide, lincosamide, streptogramin, sulfonamide, trimethoprim, protein antibiotic other than the chemically-modified peptide, chloramphenicol, metronidazole, rifampin, fosfomycin, methenamine, ethambutol, pentamidine, and the like.

The antibiotic is typically present in an amount of about 0.0001% to about 10% by weight of antibiotic based on the weight percentage of the total composition. In some embodiments, the antibiotic is present in an amount of about 0.0001% to about 5% by weight of antibiotic based on the weight percentage of the total composition. In other embodiments, the antibiotic is present in an amount of about 0.0001% to about 3% by weight of antibiotic based on the weight percentage of the total composition.

The compositions of the invention may comprise an antiviral agent as the second antimicrobial compound. Antiviral agents include, but are not limited to acyclovir, DNA synthesis inhibitors, reverse transcriptase inhibitors, protease inhibitors, IFN-α, ribavirin, and the like.

The compositions of the invention may comprise an antifungal agent as the second antimicrobial compound. The antifungal agents include, but are not limited to polyenes, imidazoles, triazoles, glucan synthesis inhibitors, and the like.

The compositions of the invention may comprise an antiparasitic as the second antimicrobial compound. Antiparasitic agents include, but are not limited to chloroquine, primaquine, sulfadoxine-pyrimethamine, metronidazole, pentamidine, benzinidazole, praziquantel, and the like.

The compositions of the invention may include at least one carrier. The carriers include, but are not limited to pharmaceutically acceptable carriers, industrially acceptable carriers, household products, and personal care compositions.

In some embodiments, the antimicrobial compositions of the invention further comprise at least one pharmaceutically acceptable carrier, such as, for example, waxes, cellulose derivatives, mineral oils, vegetable oils, petroleum derivatives, water, anhydrous lanolin, white petrolatum, liquid petrolatum, olive oil, ethanol and ethanol-polysorbate 80 solutions, propylene glycol-water solutions, jojoba oils, methylcellulose, paraffin, beeswax, glyceryl stearate, PEG-2 stearate, propylene glycol stearate, glycol stearate, cetyl alcohol, stearyl alcohol, and mixtures thereof.

The pharmaceutically acceptable carriers are typically present in an amount of about 1% to about 99% by weight of said composition. In some embodiments, the pharmaceutically acceptable carrier is present in an amount of about 50% to about 99% by weight of said composition. In other embodiments, the pharmaceutically acceptable carrier is present in an amount of about 75% to about 99% by weight of said composition.

The invention also embraces methods for preventing, inhibiting, or terminating the growth of at least one microbe by administering an antimicrobial amount of a composition of the invention. The methods are effective in preventing, inhibiting or terminating the growth of bacteria, archea, unicellular parasites, multicellular parasites, fungi, algae, and viruses. The peptides and compositions of the invention may be administered topically, orally, parenterally or as an inhalant. The compositions may be administered to animals, aqueous environments, and non-aqueous environments. The compositions may be used mixed in animal feed, or as a preservative, or applied to plants.

The invention also provides methods for preventing, inhibiting or treating biofouling of aqueous environments by administering an antimicrobial amount of a composition of the invention to the aqueous environment. The aqueous environment includes natural, artificial and recreational bodies of water. The foregoing and other objects, features and advantages of the invention will be apparent from the following more particular and the accompanying examples.

### DETAILED DESCRIPTION OF THE INVENTION

Peptides of the present invention may be used to combat microbes which include, but are not limited to, bacteria, archea, fungi (yeasts and molds), viruses, algae and parasites. These peptides may be used in various environments wherein microbial treatment is desired, such as industrial and clinical settings. The peptides may be made in accordance with any appropriate method. The peptides of the present invention are characterized by specific properties as described below. These properties include, but are not limited to, hydrophobic, cationic and structural characteristics.

The peptides of the present invention possess activity toward microbes, which activity can be described as “antimicrobial”. As used herein, the term “antimicrobial” is meant to include prevention, inhibition or termination of a microbe. “Prevention” can be considered to be the obstruction or hindrance of any potential microbial growth. “Inhibition” can be considered to be a reduction in microbial growth. This may occur via, but is not limited to, a microbiostatic mechanism such as interference in the synthesis of the cell wall or binding to ribosomal subunits to prevent production of microbial proteins. “Termination” can be considered to be actual killing of the microbes by the presence of the composition. This may occur via, but is not limited to, a microbiocidal mechanism such as a change in osmotic pressure leading to bursting of the cell or formation of leaky channels in the cell wall and membrane causing loss of cellular material.

As used herein, “microbes” is meant to include any organism comprised of the phylogenetic domains bacteria and archaea, as well as unicellular and filamentous fungi (such as yeasts and molds), unicellular and filamentous algae, unicellular and multicellular parasites, and viruses. The present invention is effective against bacteria including Gram-positive and Gram-negative cocci, Gram positive and Gram negative straight, curved and helical/vibroid and branched rods, sheathed bacteria, sulfur-oxidizing bacteria, sulfur or sulfate-reducing bacteria, spirochetes, actinomycetes and related genera, myxobacteria, mycoplasmas, rickettsias and chlamydias, cyanobacteria, archea, fungi, parasites, viruses and algae.

The Gram-positive and Gram-negative cocci include, but are not limited to, Aerococcus, Enterococcus, Halococcus, Leuconostoc, Micrococcus, Mobiluncus, Moraxella catarrhalis, Neisseria (including N. gonorrheae and N. meningitidis), Pediococcus, Peptostreptococcus, Staphylococcus species (including S. aureus, methicillin-resistant S. aureus, coagulase-negative S. aureus, and S. saprophyticus), Streptococcus species (including S. pyogenes, S. agalactiae, S. bovis, S. pneumoniae, S. mutans, S. sanguis, S. equi, S. equinus, S. thermophilus, S. morbillorum, S. hansenii, S. pleomorphus, and S. parvulus), and Veillonella.

The Gram-positive and Gram-negative straight, curved, helical/vibrioid and branched rods include, but are not limited to, Acetobacter, Acinetobacter, Actinobacillus equuli, Aeromonas, Agrobacterium, Alcaligenes, Aquaspirillum, Arcanobacterium haemolyticum, Bacillus species (including B. cereus and B. anthracis), Bacteroides species (including B. fragilis), Bartonella, Bordetella species (including B. pertussis), Brochothrix, Brucella, Burkholderia cepacia, Calymmatobacterium granulomatis, Campylobacter species (including C. jejuni), Capnocytophaga, Caulobacter, Chromobacterium violaceum, Citrobacter, Clostridium species (including C. perfringens, C. tetani and C. difficile), Comamonas, Curtobacterium, Edwardsiella, Eikenella, Enterobacter, Erwinia, Erysipelothrix, Escherichia species (including E. coli), Flavobacterium species (including F. meninosepticum), Francisella species (including F. tularensis), Fusobacterium (including F. nucleatum), Gardnerella species (including G. vaginalis), Gluconobacter, Haemophilus species (including H. influenzae and H. ducreyi), Hafnia, Helicobacter (including H. pylori), Herpetosiphon, Klebsiella species (including K. pneumoniae), Kluyvera, Lactobacillus, Legionella species (including L. pneumophila), Leptotrichia, Listeria species (including L. monocytogenes), Microbacterium, Morganella, Nitrobacter, Nitrosomonas, Pasteurella species (including P. multocida), Pectinatus, Porphyromonas gingivalis, Proteus species (including P. mirabilis), Providencia, Pseudomonas species (including P. aeruginosa, P. mallei, P. pseudomallei and P. solanacearum), Rahnella, Renibacterium salmoninarum, Salmonella, Serratia, Shigella, Spirillum, Streptobacillus species (including S. moniliformis), Vibrio species (including V. cholerae and V. vulnificus), Wolinella, Xanthobacter, Xenorhabdus, Yersinia species (including Y. pestis and Y. enterocolitica), Zanthomonas and Zymomonas.

The sheathed bacteria include, but are not limited to, Crenothrix, Leptothrix and Sphaerotilus. The sulfur-oxidizing bacteria include, but are not limited to, Beggiatoa, Gallionella, Sulfolobus, Thermothrix, Thiobacillus species (including T. ferroxidans), Thiomicrospira and Thiosphaera. The sulfur or sulfate-reducing bacteria include, but are not limited to, Desulfobacter, Desulfobulbus, Desulfococcus, Desulfomonas, Desulfosarcina, Desulfotomaculum, Desulfovibrio and Desulfuromonas. The spirochetes include, but are not limited to, Treponema species (including T. pallidum, T. pertenue, T. hyodysenteriae and T. denticola), Borrelia species (including B. burgdorferi and B. recurrentis), Leptospira and Serpulina. The actinomycetes and related genera include, but are not limited to, Acetobacterium, Actinomyces species (including A. israelii), Bifidobacterium, Brevibacterium, Corynebacterium species (including C. diphtheriae, C. insidiosum, C. michiganese, C. rathayi, C. sepedonicum, C. nebraskense), Dermatophilus, Eubacterium, Mycobacterium species (including M. tuberculosis and M. leprae), Nocardia, Propionibacterium, Rhodococcus and Streptomyces.

The myxobacteria include, but are not limited to, Chondromyces, Cystobacter, Melittangium, Myxococcus, Nannocystis, Polyangium and Stigmatella. The mycoplasmas include, but are not limited to, Mycoplasma species (including M. pneumoniae), Mycoplasma-like organisms of plants and invertebrates, Spiroplasma and Ureaplasma species (including U. urealyticum).

The rickettsias and chlamydias include, but are not limited to, Aegyptianella, Anaplasma, Chlamydia species (including C. pneumoniae, C. trachomatis and C. psittaci), Cowdria, Coxiella, Ehrlichia, Eperythrozoon, Haemobartonella, Neorickettsia, Rickettsia and Rickettsiella. The cyanobacteria include, but are not limited to, Anabaena, Nostoc, Oscillatoria, Pleurocapsa, Prochloron and Synechococcus.

The archea include, but are not limited to, all methanogens (Methanobacterium, Methanobrevibacter, Methanococcoides, Methanococcus, Methanogenium, Methanolobus, Methanomicrobium, Methanoplanus, Methanosarcina, Methanospirillum, Methanothermus and Methanothrix), and the genera Acidianus, Archaeoglobus, Desulfurococcus, Haloarcula, Halobacterium, Halococcus, Haloferax, Natronobacterium, Natronococcus, Pyrococcus, Pyrodictium, Staphylothermus, Sulfolobus, Thermococcus, Thermophila, Thermoplasma and Thermoproteus.

The present invention may also be used against fungi which include, but are not limited to, Acremonium, Aspergillus, Blastomyces species (including B. dermatitidis), Candida species (including C. albicans), Ceratocystis, Chaetomium, Coccidioides species (including C. immitis), Cryptococcus neoformans, Epidermophyton, Fusarium species (including F. oxysporum), Gongronella, Histoplasma species (including H. capsulatum), Hormonea, Malassezia furfur, Microsporum, Mycosphaerella fjiensis, Paracoccidiodes brasiliensis, Penicillium, Pneumocystis carinii, Pythium, Rhizoctonia, Rhodotorula, Saccharomyces, Sporothrix schenckii, Torula, Trichoderma, Trichophyton species (including T. mentagrophytes and T. rubrum) and Trichothecium.

The present invention may be used against parasites which include, but are not limited to, Acanthamoeba species, Ascaris lumbricoides, Babesia, Balamuthia, Balantidium, Blastocystis species including B. hominis, Chilomastix, Clonorchis sinensis, Cryptosporidium parvum, Cyclospora, Dientamoeba fragilis, Diphyllobothrium, Echinococcus, Endolimax, Entamoeba species (including E. histolytica), Enterobius species (including E. vermicularis), Giardia lamblia, hookworms (including Necator, Ancylostoma, and Unicinaria), Hymenolepsis, Iodamoeba, Isospora, Leishmania, Mansonella, microsporidia, Microsporidium, Naegleria fowleri, Onchocerca, Plasm odium (including P. falciparum, P. vivax, P. ovale and P. malariae), Schistosoma (including S. haematobium and S. mansoni), Strongyloides species (including S. stercoralis), tapeworms (including Taenia species), Toxoplasma (including T. gondii), Trichinella (including T. spiralis), Trichomonas vaginalis, Trichuris species including T. trichiura, Trypanosoma, Dirofilaria, Brugia, Wuchereria, Vorticella, Eimeria species, Hexamita species and Histomonas meleagidis.

The present invention may also be used against viruses which include, but are not limited, to adenovirus, arborviruses (including hanta virus), astrovirus, coronavirus, cytomegalovirus, enteroviruses (including coxsackievirus A), Epstein-Barr virus, hepatitis A virus, hepatitis B virus, herpes viruses (including herpes simples virus or HSV), human immunodeficiency virus (HIV), human papilloma virus, human T-cell leukemia virus, influenza virus, mumps virus, Norwalk viruses, orbivirus, parainfluenzae viruses, parvovirus B19, poxviruses, Rabies virus, respiratory syncytial virus, rhinovirus, rotavirus, Rubella virus, varicella-zoster virus, vesicular stomatitis virus, cauliflower mosaic virus, cowpea mosaic virus, cowpox virus and rabbit myxomatis virus.

In addition, the present invention may be used against algae which include, but are not limited to, Chlorella, Fragilaria, Gomphonema, Navicula, Nitzschia, Pfiesteria (dinoflagellate), Scenedesmus, Skeletoneona and Ulothrix.

The peptides of this invention are useful in the treatment of diseases caused by, but not limited to, bacteria, fungi, viruses and parasites in animals, plants, avian and aquatic organisms. The clinical diseases or infections caused by gram-positive and/or gram-negative bacteria, and treatable with the present invention include abscesses, bacteremia, contamination of peritoneal dialysis fluid, endocarditis, pneumonia, meningitis, osteomyelitis, cellulitis, pharyngitis, otitis media, sinusitis, scarlet fever, arthritis, urinary tract infection, laryngotracheitis, erysipeloid, gas gangrene, tetanus, typhoid fever, acute gastroenteritis, bronchitis, epiglottitis, plague, sepsis, chancroid, wound and burn infection, cholera, glanders, periodontitis, genital infections, empyema, granuloma inguinale, Legionnaire's disease, paratyphoid, bacillary dysentary, brucellosis, diphtheria, pertussis, botulism, toxic shock syndrome, mastitis, rheumatic fever, cystic fibrosis, eye infections, plaque, and dental caries. Other uses include swine erysipelas, peritonitis, abortion, encephalitis, anthrax, nocardiosis, pericarditis, mycetoma, peptic ulcer, melioidosis, Haverhill fever, tularemia, Moko disease, galls (such as crown, cane and leaf), hairy root, bacterial rot, bacterial blight, bacterial brown spot, bacterial wilt, bacterial fin rot, dropsy, columnaris disease, pasteurellosis, furunculosis, enteric redmouth disease, vibriosis of fish, fouling of medical devices.

Peptides of the present invention may also be useful in treating diseases caused by spirochetes including syphilis, yaws, Lyme disease, Weil's disease, meningitis, leptospirosis, tick- and louse-borne relapsing fever, tick spirochetosis and canine, avian, rodent or lagomorph borreliosis. In addition, diseases caused by actinomycetes may be treatable by the present invention including tuberculosis, leprosy, cervicofacial lesions, abdominal lesions, thoracic lesions, pulmonary lesions and lesions of other organs, leafy gall and fish corynebacteriosis. Treatable rickettsial and chlamydial diseases or infections by the present invention include psittacosis, boutonneuse fever, ehrlichiosis, typhus fever, murine typhus, Brill's disease, Rocky Mountain spotted fever, Q fever, rickettsial pox, lymphogranuloma venereum, urethritis and trachoma. Treatable diseases or infections by mycoplasma include lethal yellowing.

Fungal infections treatable by the present invention include oral, cutaneous and vaginal thrush, cryptococcosis, superficial mycosis (including Athlete's foot), subcutaneous mycosis (including sporotrichosis), systemic mycosis (including histoplasmosis and coccidioidomycosis), Farmer's lung, aflatoxin disease, histoplasmosis, pneumonia, endocardititis, burn infections, mucormycosis, pityriasis versicolor, fungemia due to indwelling catheter infections, damping off, rot, panama disease, black leaf streak, anthracnose, apple scab, black knot, rust, canker, gray mold, blue mold, blight, powdery and downy mildew, wilt, damping off and leaf spot.

Viral infections treatable by the present invention include common colds, hemorrhagic fevers, mononucleosis, genital disease, keratoconjunctivitis, encephalitis, neonatal HSV, mucocutaneous HSV, chicken pox, retinitis, AIDS, influenza, pneumonia, bronchiolitis, genital papilloma, measles (including German measles), rabies, rubella, mumps, shingles, poliomyelitis, viral diarrhea, yellow fever, zoster, roseola, laryngotracheobronchitis, gastroenteritis, hepatitis (including hepatitis A and B), dengue fever, orf virus infection, molluscum contagiosum virus infection, fruit and vegetable mosaic viruses, tobacco ringspot virus, leaf curl virus, dropsy, cauliflower disease and necrotic viruses of fish.

Parasitic infections treatable by the present invention include trichinosis, malaria, giardiasis, amoebiasis, schistosomiasis, encephalitis, keratitis, gastroenteritis, urogenital infections, toxoplasmosis, African sleeping sickness, white spot disease, slimy skin disease, chilodonella, costia, hexamitiasis, velvet and coral fish disease.

Peptides of the present invention are also useful as infection or inflammation seeking agents or as T-cell activators.

The present invention is useful in a variety of environments including industrial, clinical, the household, and personal care. The peptide compositions of the present invention for industrial, pharmaceutical, household and personal care use may comprise at least one active ingredient, of which the peptide of the present invention is an active ingredient acting alone, additively, or synergistically against the target microbe.

The peptides of this invention may be delivered in a form suitable for its use in environments including industry, pharmaceutics, household, and personal care. The peptides of the present invention are preferably soluble in water and may be applied or delivered with an acceptable carrier system. The composition may be applied or delivered with a suitable carrier system such that the active ingredient may be dispersed or dissolved in a stable manner so that the active ingredient, when it is administered directly or indirectly, is present in a form in which it is available in a particularly advantageous way.

Also, the separate components of the peptide compositions of the present invention may be preblended or each component may be added separately to the same environment according to a predetermined dosage for the purpose of achieving the desired concentration level of the treatment components and so long as the components eventually come into intimate admixture with each other. Further, the present invention may be administered or delivered on a continuous or intermittent basis.

The peptides of the present invention, when present in a composition will preferably be present in an amount from about 0.000001% to about 100%, more preferably from about 0.001% to about 50%, and most preferably from about 0.01% to about 25%.

For compositions of the present invention comprising peptides, when a carrier is present, the composition comprises preferably from about 1% to about 99%, more preferably from about 50% to about 99%, and most preferably from about 75% to about 99% by weight of at least one carrier.

Peptide compositions of the present invention may include any biocide or biodispersant known in the art. Preferably, the biocides include dodecylguanidine hydrochloride, methylene bis(thiocyanate), n-alkyl dimethylbenzylammonium chloride, glutaraldehyde, 2,2-dibromo-3-nitrilo propionamide, 5-chloro-2-methyl-4-isothiazolin-3-one, 2-methyl-4-isothiazolin-3-one, or 2-bromo-2-nitropropane-1,3-diol, sodium or calcium hypochlorite, sodium bromide, β-bromo-β-nitrostyrene, oxazolidines, chromated copper arsenate, zinc or copper pyrithione, carbamates or halohydantoins. Biodispersants include dinonylsulfosuccinate and sodium lauryl sulfate.

Biocides and biodispersants in the compositions of the present invention, are preferably present in an amount from about 0.0000002% to about 5%, more preferably from about 0.0000002% to about 2%, and most preferably from about 0.0000002% to about 1% by weight of biocide based on the weight percentage of the total composition.

The ratio of peptide to biocide in the compositions of the present invention ranges preferably from about 5:1 to about 25:1 of peptide to biocide, more preferably about 5,000:1 to about 25:1 of peptide to biocide, and most preferably from about 50,000:1 to about 25:1 of peptide to biocide.

Peptide compositions of the present invention may include any biocide formulation known in the art. Preferably, the biocide formulations include 2,2-dibromo-3-nitrilo propionamide, 5-chloro-2-methyl-4-isothiazolin-3-one and 2-methyl-4-isothiazolin-3-one; dodecylguanidine hydrochloride and methylene bis(thiocyanate), β-bromo-β-nitrostyrene (BNS), n-alkyl dimethylbenzylammonium chloride; 2-bromo-2-nitropropane-1,3-diol, oxazolidines chromated copper arsenate, zinc or copper pyrithione, carbamates or halohydantoins.

Peptide compositions of the present invention may include any one or more germicides or preservatives known in the art. Preferably, the germicides or preservatives include 2,4,4′-trichloro-2′-hydroxydiphenylether (triclosan), 1-(4-chlorophenyl)-3-(3,4-dichlorophenyl)urea (3,4,4-trichlorocarbanilide), isopropylmethylphenol, chlorhexidine hydrochloride, hexamidine diisethionate, octopirox, chloroxylenol, benzoyl peroxide, phenoxy alcohols, or hydroxybenzoic acids.

The germicide or preservative present in a peptide composition of the present invention will preferably be present in an amount of about 0.0001% to about 10%, more preferably from about 0.0001% to about 5%, and most preferably from about 0.0001% to about 3% by weight of germicide or preservative based on the weight percentage of the total composition.

The ratio of peptide to germicide or preservative in peptide compositions of the present invention ranges from preferably about 0.01:1 to about 8:1 of peptide to germicide or preservative, more preferably from about 0.1:1 to about 8:1 of peptide to germicide or preservative, and most preferably from about 100:1 to about 8:1 of peptide to germicide or preservative.

Peptide compositions may include any antibacterial, antiviral, antifungal or antiparasitic agent known in the art. The antibacterial agents may include penicillins (such as methicillin, oxacillin, ampicillin, carbenicillin or piperacillin), cephalosporins (such as cephalexin, cefoxitin, cefotamine or cefepine), carbapenems (such as imipenem), β-lactamase inhibitors (such as clavulanic acid), aminoglycosides and aminocyclitols (such as streptomycin), quinolones (such as norfloxacin, ciprofloxacin or ofloxacin), macrolides (such as erythromycin), tetracyclines (such as chlortetracycline or doxycycline), glycopeptides and lipopeptides (such as vancomycin), lincosamides (such as clindamycin), streptogramins (such as pristinamycin II_{A} and I_{A}), sulfonamides and trimethoprim, polypeptides (such as polymyxin), chloramphenicol, metronidazole, rifampin, fosfomycin, methenamine, ethambutol or pentamidine.

The antiviral agents include inhibitors of viral DNA polymerase such as acyclovir, inhibitors of DNA synthesis such as trifluridine, inhibitors of reverse transcriptase, such as 3TC or delavirdine, protease inhibitors such as indinavir, as well as amantidine, IFN-α or ribavirin.

Antifungal agents include polyenes, such as amphotericin B, imidazoles, such as miconazole, triazoles, such as fluconazole, or glucan synthesis inhibitors, such as LY303366.

Antiparasitic agents include chloroquine, primaquine, sulfadoxine-pyrimethamine, metronidazole, pentamidine, benznidazole or praziquantel.

The antibacterial, antiviral, antifungal or antiparasitic agent present in a peptide composition of the present invention will preferably be present in an amount of about 0.0001% to about 10%, more preferably from about 0.0001% to about 5%, and most preferably from about 0.0001% to about 3% by weight of antibacterials, antivirals, antifungals or antiparasitic agents based on the weight percentage of the total composition.

The ratio of peptide to antibiotic in peptide compositions of the present invention ranges from preferably about 0.01:1 to about 8:1 of peptide to antibacterial, antiviral, antifungal or antiparasitic agent, more preferably from about 0.1:1 to about 8:1 of peptide to antibacterial, antiviral, antifungal or antiparasitic agent, and most preferably from about 100:1 to about 8:1 of peptide to antibacterial, antiviral, antifungal or antiparasitic agent.

The present invention and any suitable carrier may be prepared for delivery in forms including solution, microemulsion, suspension or aerosol. Generation of the aerosol or any other means of delivery of the present invention may be accomplished by any of the methods known in the art. For example, in the case of aerosol delivery, the antimicrobial composition is supplied in a finely divided form along with any suitable carrier with a propellant. Liquified propellants are typically gases at ambient conditions and are condensed under pressure. The propellant may be any acceptable and known in the art including propane and butane, or other lower alkanes, such as those of up to 5 carbons. The antimicrobial composition is held within a container with an appropriate propellant and valve, and maintained at elevated pressure until released by action of the valve.

The compositions may be prepared in a conventional form suitable for, but not limited to topical or local application such as an ointment, paste, gel, spray and liquid, by including stabilizers, penetrants and the carrier or diluent with peptide according to a known technique in the art. These preparations may be prepared in a conventional form suitable for enteral, parenteral, topical or inhalational applications.

The present invention may be used in compositions suitable for household use. For example, compositions of the present invention are also useful as an active antimicrobial ingredient in household products such as cleansers, detergents, astringents, disinfectants, dishwashing liquids, soaps and detergents. The antimicrobial composition of the present invention may be delivered in an amount and form effective for the prevention, removal or termination of microbes.

The antimicrobial composition for household use may be defined as comprising at least one peptide of the present application and at least one suitable carrier.

Preferably, the composition comprises from about 0.00001% to about 50%, more preferably from about 0.0001% to about 25%, most preferably from about 0.0005% to about 10% by weight of peptide based on the weight percentage of the total composition.

The present invention may further be used in hygiene compositions for personal care. For instance, compositions of the present invention are useful as an active ingredient in personal care products such as facial cleansers, astringents, body wash, shampoos, conditioners, cosmetics and other hygiene products. The hygiene composition may comprise any carrier or vehicle known in the art to obtain the desired form (such as solid, liquid, semisolid or aerosol) as long as the effects of the peptide of the present invention are not impaired. Methods of preparation of hygiene compositions are not described herein in detail, but are known in the art. For its discussion of such methods, The CTFA Cosmetic Ingredient Handbook, Second Edition, 1992, and pages 5-484 of A Formulary of Cosmetic Preparations (Vol. 2, Chapters 7-16) are incorporated herein by reference.

The hygiene composition for use in personal care may be defined as comprising at least one peptide of the present application and at least one suitable carrier. Preferably, the composition comprises from about 0.00001% to about 50%, more preferably from about 0.0001% to about 25%, most preferably from about 0.0005% to about 10% by weight of peptide based on the weight percentage of the total composition.

The peptides of the present invention may be used in industry. In the industrial setting, the presence of microbes can be problematic, as microbes are often responsible for industrial contamination and biofouling. Antimicrobial compositions for industrial applications comprise an effective amount of the peptides of the present invention in an antimicrobial composition for industrial use with at least one acceptable carrier or vehicle known in the art to be useful in the treatment of such systems. Such carriers or vehicles may include diluents, defloculating agents, penetrants, spreading agents, surfactants, suspending agents, wetting agents, stabilizing agents, compatability agents, sticking agents, waxes, oils, co-solvents, coupling agents, foams, antifoaming agents, natural or synthetic polymers, elastomers and synergists. Methods of preparation, delivery systems and carriers for such antimicrobial compositions are not described here in detail, but are known in the art. For its discussion of such methods, U.S. Pat. No. 5,939,086 is herein incorporated by reference. Furthermore, the preferred amount of antimicrobial composition to be used may vary according to the peptide and situation in which the composition is being applied.

The antimicrobial compositions of the present invention may be useful in nonaqueous environments. Such nonaqueous environments may include, but are not limited to, terrestrial environments, dry surfaces or semi-dry surfaces in which the antimicrobial composition is applied in a manner and amount suitable for the situation. The antimicrobial compositions of the present invention may be used to form contact-killing coatings or layers on a variety of substrates including personal care products (such as toothbrushes, contact lens cases and dental equipment), healthcare products, household products, food preparation surfaces and packaging, and laboratory and scientific equipment. Further, other substrates include medical devices such as catheters, urological devices, blood collection and transfer devices, tracheotomy devices, intraocular lenses, wound dressings, sutures, surgical staples, membranes, shunts, gloves, tissue patches, prosthetic devices (e.g., heart valves) and wound drainage tubes. Still further, other substrates include textile products such as carpets and fabrics, paints and joint cement. A further use is as an antimicrobial soil fumigant.

The peptides may also be incorporated into polymers, such as polysaccharides (cellulose, cellulose derivatives, starch, pectins, alginate, chitin, guar, carrageenan), glycol polymers, polyesters, polyurethanes, polyacrylates, polyacrylonitrile, polyamides (e.g., nylons), polyolefins, polystyrenes, vinyl polymers, polypropylene, silks or biopolymers. The peptides may be conjugated to any polymeric material, such as those with the following specified functionality: 1) carboxy acid, 2) amino group, 3) hydroxyl group and/or 4) haloalkyl group.

The antimicrobial composition for treatment of nonaqueous environments may be defined as comprising at least one peptide of the present application and at least one suitable carrier. Preferably, the composition comprises from about 0.001% to about 75%, more preferably from about 0.01% to about 50%, most preferably from about 0.1% to about 25% by weight of peptide based on the weight percentage of the total composition.

The antimicrobial compositions of the present invention may be useful in aqueous environments which include natural bodies of water such as lakes or ponds; artificial, recreational bodies of water such as swimming pools and hot tubs; and drinking reservoirs such as wells. The antimicrobial compositions of the present invention are useful in treating microbial growth in these aqueous environments and may be applied at or near the surface of water.

The antimicrobial composition for treatment of aqueous environments may be defined as comprising at least one peptide of the present application and at least one suitable carrier. Preferably, the composition comprises from about 0.001% to about 50%, more preferably from about 0.003% to about 15%, most preferably from about 0.01% to about 5% by weight of peptide based on the weight percentage of the total composition.

The composition of the present invention may be administered for clinical use, in a therapeutically effective amount and composition, to beings infected with a microorganism discussed above. Beings treatable clinically include all land, air and water animals, and plants, but preferably mammals and most preferably humans. Alternatively, the composition may be administered prophylactically. The therapeutic and prophylactic dose for the present invention may vary according to several factors including the age, weight, and condition of the individual, route of administration and/or other drug interactions. The principles and factors for determining dosage are not discussed here in detail, but are known in the art and may be referenced in pages 1-83 of Goodman and Gilman's The Pharmacological Basis of Therapeutics (8th Edition). The preferred doses for therapeutic and prophylactic treatment may vary and can be adjusted to suit the individual and situation.

The therapeutically and prophylactically effective amount is preferably from about 0.5 mg/kg to about 100 mg/kg, more preferably from about 1 mg/kg to about 20 mg/kg, and most preferably from about 2 mg/kg to about 10 mg/kg.

In addition to the foregoing, the present invention also provides a process for the production of a pharmaceutical composition. Such process comprises bringing at least one of the individual components described thereof into intimate admixture with a peptide of the present invention, and when required, compounding the obtained composition in unit dosage form, for example filling said composition into a gelatin, e.g., soft or hard gelatin, capsules. Methods of preparation of pharmaceutical compositions are not described here in detail, but are known in the art. For its discussion of such methods, pages 1435-1694 of Remington's Pharmaceutical Sciences (Part 8) are incorporated herein by reference.

The pharmaceutical composition may be defined as comprising at least one peptide of the present application and at least one suitable carrier. Preferably, the composition comprises from about 0.000001% to about 75%, more preferably from about 0.00001% to about 25%, most preferably from about 0.0001% to about 12% by weight of peptide based on the weight percentage of the total composition.

The pharmaceutical composition may be administered for treatment of any land, air or water animal potentially having or having at least one microbial infection. Treatment of an animal with the present invention may also include prophylactic treatment. The mode of administration is such as to deliver a binding inhibiting effective amount of the pharmaceutical composition to the site of infection. For example, therapeutic delivery of the pharmaceutical composition may be achieved via enteral administration which includes oral, sublingual and rectal administration or via parenteral administration which includes intramuscular, intravenous and subcutaneous administration. Alternatively, therapeutic delivery of the pharmaceutical composition may also be achieved via other routes including topical and inhalational. Again, as discussed above, preferred dosage ranges will vary according to the individual and situation.

Enteral administration of the pharmaceutical composition is preferably administered at a dosage of from about 0.01 mg/kg to about 100 mg/kg, more preferably from about 2 mg/kg to about 50 mg/kg, and most preferably from about 5 mg/kg to about 30 mg/kg.

Parenteral administration of the pharmaceutical composition is preferably administered at a dosage from about 0.01 mg/kg to about 100 mg/kg, more preferably from about 1 mg/kg to about 30 mg/kg, and most preferably from about 5 mg/kg to about 25 mg/kg.

Topical administration of the pharmaceutical composition is preferably administered at a dosage from about 0.000001% to about 20%, more preferably from about 0.001% to about 15%, and most preferably from about 0.025% to about 10%.

Inhalational administration of the pharmaceutical composition is preferably administered at a dosage from about 0.0001 mg to about 25 mg, more preferably from about 0.01 mg to about 15 mg, and most preferably from about 0.1 mg to about 10 mg.

The peptides of this invention may be delivered in a pharmaceutically acceptable composition suitable for any of the routes of administration discussed above. “Pharmaceutically acceptable” is used herein to refer to those materials which are within the scope of sound medical judgement, suitable for use in contact with the tissue of humans and lower animals, avian and aquatic organisms without undue toxicity, irritation, allergic response and the like commensurate with a reasonable benefit/risk ratio, and effective for their intended use in the composition.

The pharmaceutical composition may include, but is not limited to, at least one acceptable carrier. The carrier is generally an inert bulk agent added to make the active ingredients easier to handle and can be solid, semisolid or liquid in the usual manner as well as understood in the art. Such a carrier may be a solvent, diluent or carrier comprising of waxes, cellulose derivatives, mineral oils, vegetable oils, petroleum derivatives, water, anhydrous lanolin, white petrolatum, liquid petrolatum, olive oil, ethanol and ethanol-polysorbate 80 solutions, propylene glycol-water solutions, and jojoba oils, methylcellulose or paraffin, beeswax, glyceryl stearate, PEG-2 stearate, propylene glycol stearate, glycol stearate, cetyl alcohol, stearyl alcohol, and any mixture thereof. Carriers used may include commercially available carriers or vehicles including Aquaphor® ointment base (Beirsdorf Inc.,), Eucerin® creme/lotion (Beirsdorf), Acid Mantle® (Sandoz), Nutraderm® creme/lotion (Owen), Vehicle/N® or Vehicle/N® Mild (Neutrogena).

Pharmaceutical compositions of the invention may also include any delivery vehicle or device known in the art to enhance the transport of peptides across tissue and/or cell surfaces to reach the circulatory system and/or target site. Such delivery vehicles or devices may include liposomes or immunogenic liposomes, which may be adminstered in admixture with any carrier (discussed above) with regard to the intended route of administration, and standard pharmaceutical practice. Dosages of peptides associated with such delivery vehicles or devices will vary according to certain factors including the age, weight, and condition of the individual, as well as the pharmacokinetics and release characteristics of the peptide from the delivery vehicles or devices. Further, the ratio of peptide to liposome and carrier will depend on the chemical nature, solubility, trapping efficiency, and stability of the peptide, as well as the dosage anticipated. Maximal delivery of the peptide of the present invention may be accomplished by varying the lipid:peptide ratio as well as the type of peptide and liposome used.

The present invention also provides a process for the production of an antibiofouling composition for industrial use. Such process comprises bringing at least one of any industrially acceptable carrier known in the art into intimate admixture with a peptide of the present invention. The carrier may be any suitable carrier discussed above or known in the art.

The suitable antibiofouling compositions may be in any acceptable form for delivery of the composition to a site potentially having, or having at least one living microbe. The antibiofouling compositions may be delivered with at least one suitably selected carrier as hereinbefore discussed using standard formulations. The mode of delivery may be such as to have a binding inhibiting effective amount of the antibiofouling composition at a site potentially having, or having at least one living microbe. The antibiofouling compositions of the present invention are useful in treating microbial growth that contributes to biofouling, such as scum or slime formation, in these aqueous environments. Examples of industrial processes in which these compounds might be effective include cooling water systems, reverse osmosis membranes, pulp and paper systems, air washer systems and the food processing industry. The antibiofouling composition may be delivered in an amount and form effective for the prevention, removal or termination of microbes.

The antibiofouling composition of the present invention preferably comprises at least one peptide from about 0.001% to about 50%, more preferably from about 0.003% to about 15%, most preferably from about 0.01% to about 5% by weight of peptide based on the weight percentage of the total composition.

The amount of antibiofouling composition is preferably delivered in an amount of about 1 mg/l to about 1000 mg/l, more preferably from about 2 mg/l to about 500 mg/l, and most preferably from about 20 mg/l to about 140 mg/l.

The peptides of the present invention may be delivered at a minimum inhibitory concentration. The “minimum inhibitory concentration” (MIC) is used herein to refer to the lowest concentration of the peptides of the present invention required to inhibit greater than or equal to 90% microbial growth. The MIC for the peptides of the present invention is preferably less than or equal to 100 μg/ml, more preferably less than or equal to 50 μg/ml, and most preferably less than or equal to 10 μg/ml.

The peptides of the present invention may be modified at the N- and/or C-terminus. “Modifications” as used herein include modifications at the N-terminus and/or C-terminus or modification of any position on at least one amino acid residue. The modified peptides may be represented by, for example, Formula I:

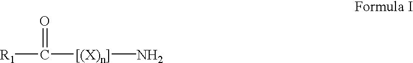

wherein:

X represents any of the natural or non-natural, modified or unmodified amino acids except glutamate (Glu) or aspartate (Asp);

n=1 to 5;

R₁ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₃ is independently hydrogen; C₁-C₄ alkyl; or phenyl optionally substituted with at least one R₈;

R₄ is independently hydrogen; C₁-C₈ alkyl; or phenyl optionally substituted with at least one R₈;

R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;

R₆ is independently methyl; ethyl; methoxy; methylthio; halogen; or trifluoromethyl;

R₇ is independently halogen; and

R₈ is independently halogen; C₁-C₄ alkyl; C₁-C₄ alkoxy; C₁-C₄ haloalkyl; nitro; or cyano.

The modified peptides may be represented by, for example, Formula II:

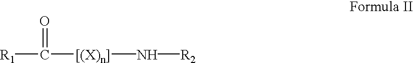

wherein:

X represents any of the natural or non-natural, modified or unmodified amino acids except glutamate (Glu) or aspartate (Asp);

n=1 to 10;

when the chemically-modified peptide is 1-3 amino acids, at least one amino acid is a cationic amino acid, the net charge of the chemically-modified peptide at neutral pH is at least +1, and the chemically-modified peptide does not contain glutamate or aspartate;

when the chemically-modified peptide is 4-5 amino acids, at least two of the amino acids are cationic amino acids, the net charge of the chemically-modified peptide at neutral pH is at least +2, and the chemically-modified peptide does not contain glutamate or aspartate;

when the chemically-modified peptide is 6-8 amino acids, at least three of the amino acids are cationic amino acids, the net charge of the chemically-modified peptide at neutral pH is preferably at least +3, and the chemically-modified peptide does not contain glutamate or aspartate; and

when the chemically-modified peptide is 9-10 amino acids, at least four of the amino acids are cationic amino acids, the net charge of the chemically-modified peptide at neutral pH is preferably at least +4, and the chemically-modified peptide does not contain glutamate or aspartate;

R₁ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;

R₃ is independently hydrogen; C₁-C₄ alkyl; or phenyl optionally substituted with at least one R₈;

R₄ is independently hydrogen; C₁-C₈ alkyl; or phenyl optionally substituted with at least one R₈;

R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;

R₆ is independently methyl; ethyl; methoxy; methylthio; halogen; or trifluoromethyl;

R₇ is independently halogen; and

R₈ is independently halogen; C₁-C₄ alkyl; C₁-C₄ alkoxy; C₁-C₄ haloalkyl; nitro; or cyano.

As used herein, “hydrocarbyl” is defined by R₁ and R₂.

In the above recitations, the term “alkyl”, used either alone or in compound words such as “alkylthio,” “haloalkyl,” or “alkylthioalkyl” denotes straight-chain or branched alkyl; e.g., methyl, ethyl, n-propyl, i-propyl, or the different butyl, pentyl, hexyl, etc. isomers.

“Cycloalkyl” denotes cyclopropyl, cyclobutyl, cyclopentyl, and cyclohexyl.

The term “cycloalkyloxyalkyl” denotes the cycloalkyl groups linked through an oxygen atom to an alkyl chain. Examples include cyclopentyloxymethyl and cyclohexyloxybutyl. The term “cycloalkylthioalkyl” are the cycloalkyl groups linked through a sulfur atom to an alkyl chain; e.g., cyclopropylthiopentyl. “Cycloalkylalkyl” denotes a cycloalkyl ring attached to a branched or straight-chain alkyl; e.g. cyclopropylmethyl and cyclohexylbutyl.

“Cycloalkylalkyl” denotes a cycloalkyl ring attached to a branched or straight-chain alkyl; e.g. cyclopropylmethyl and cyclohexylbutyl.

“Alkenyl” denotes straight chain or branched alkenes; e.g., 1-propenyl, 2-propenyl, 3-propenyl and the different butenyl, pentenyl, hexenyl, etc. isomers. Alkenyl also denotes polyenes such as 1,3-hexadiene and 2,4,6-heptatriene.

“Alkynyl” denotes straight chain or branched alkynes; e.g., ethynyl, 1-propynyl, 3-propynyl and the different butynyl, pentynyl, hexynyl, etc. isomers. “Alkynyl” can also denote moieties comprised of multiple triple bonds; e.g., 2,7-octadiyne and 2,5,8-decatriyne.

“Alkoxy” denotes methoxy, ethoxy, n-propyloxy, isopropyloxy and the different butoxy, pentoxy, hexyloxy, etc. isomers. “Alkoxyalkenyl” and “alkoxyalkynyl” denoted groups in which the alkoxy group is bonded through the oxygen atom to an alkenyl or alkynyl group, respectively. Examples include CH₃OCH₂CH═CH and (CH₃)₂CHOCH₂C≡CCH₂. The corresponding sulfur derivatives are denoted “alkylthioalkenyl” and “alkylthioalkynyl.”Examples of the former include CH₃SCH₂CH═CH and CH₃CH₂SCH₂(CH₃)CH═CHCH₂, and an example of the latter is CH₃CH₂CH₂CH₂SCH₂C≡C.

“Alkenyloxy” denotes straight chain or branched alkenyloxy moieties. Examples of alkenyloxy include H₂C═CHCH₂O, (CH₃)₂C═CHCH₂O, (CH₃)CH═CHCH₂O, (CH₃)CH═C(CH₃)CH₂O and CH₂═CHCH₂CH₂O. “Alkenylthio” denotes the similar groups wherein the oxygen atom is replaced with a sulfur atom; e.g., H₂C═CHCH₂S and (CH₃)CH═C(CH₃)CH₂S. The term “alkenyloxyalkyl” denotes groups in which the alkenyloxy moiety is attached to an alkyl group. Examples include H₂C═CHCH₂OCH₂CH₂, H₂C═CHCH₂OCH(CH₃)CH₂, etc. “Alkenylthioalkyl” denotes the alkenylthio moieties bonded to an alkyl group. Examples include H₂C═CHCH₂SCH(CH₃)CH(CH₃) and (CH₃)CH═C(CH₃)CH₂SCH₂.

“Alkynyloxy” denotes straight or branched alkynyloxy moieties. Examples include HC≡CCH₂O, CH₃C≡CH₂O and CH₃C≡CCH₂CH₂O. “Alkynyloxyalkyl” denotes alkynyloxy moieties bonded to alkyl groups; e.g., CH₃C≡CH₂OCH₂CH₂ and HC≡CH₂OCH(CH₃)CH₂. “Alkynylthioalkyl” denotes alkynylthio moieties bonded to alkyl groups. Example include CH₃C≡CH₂SCH₂CH₂ and CH₃C≡CH₂CH₂SCH(CH₃)CH₂.

“Alkylthio” denotes methylthio, ethylthio, and the different propylthio, butylthio, pentylthio and hexylthio isomers. “Alkylthioalkyl” denotes alkylthio groups attached to an alkyl chain; e.g., CH₃CH₂SCH₂CH(CH₃) and (CH₃)₂ CHSCH₂.

“Alkylsulfinyl” denotes both enantiomers of an alkylsulfinyl group. For example, CH₃S(O), CH₃CH₂S(O), CH₃CH₂CH₂S(O), (CH₃)₂CHS(O) and the different butylsulfinyl, pentylsulfinyl and hexylsufinyl isomers. “Alkylsulfinylalkyl” denotes alkylsulfinyl groups attached to an alkyl chain; e.g., CH₃CH₂S(O)CH₂CH(CH₃) and (CH₃)₂CHS(O)CH₂.

Examples of “alkylsulfonyl” include CH₃S(O)₂, CH₃CH₂S(O)₂, CH₃CH₂CH₂(CH₃)₂CHS(O)₂ and the different butylsulfonyl, pentylsulfonyl and hexylsulfonyl isomers. “Alkylsulfonylalkyl” denotes alkylsulfonyl groups attached to an alkyl chain; e.g., CH₃CH₂S(O)₂CH₂CH(CH3) and (CH₃)₂CHS(O)₂CH₂.

The term “halogen”, either alone or in compound words such as “haloalkyl”, denotes fluorine, chlorine, bromine or iodine. Further, when used in compound words such as “haloalkyl,” said alkyl may be partially or fully substituted with halogen atoms which may be the same or different. Examples of “haloalkyl” include F₃C, ClCH₂, CF₃CH₂ and CF₃CF₂. Examples of “haloalkenyl” include (Cl)₂C═CHCH₂ and CF₃CH₂CH═CHCH₂. “Haloalkenyloxyalkyl” denotes haloalkenyl groups bonded to oxygen and in turn bonded to alkyl groups. Examples include CF₃CH₂CH═CHCH₂OCH₂ and (Cl)₂C═CHCH₂OCH₂CH₂. Examples of “haloalkynyl” include HC≡CCHCl, CF₃C≡C, CCl₃C≡C and FCH₂C≡CH₂. “Haloalkynyloxyalkyl” denotes haloalkynyl groups bonded through an oxygen atom to an alkyl moiety. Examples include CF₃C≡CCH₂OCH₂CH₂, ClCH₂C≡CCH₂CH₂OCH(CH₃), etc. Examples of “haloalkoxy” include CF₃O, CCl₃CH₂O, CF₂HCH₂CH₂O and CF₃CH₂O. “Haloalkoxyalkyl” denotes haloalkoxy groups bonded to straight-chain or branched alkyl groups; e.g., CF₂HCH₂CH₂OCH₂CH₂, CCl₃CH₂OCH(CH₃) and CF₃OCH₂.

“Trialkylsilyl” designates a group with three alkyl groups bonded to silicon; e.g., (CH₃)₃Si and t-Bu(CH₃)₂Si. “Trialkylsilylalkyl” denotes trialkylsilyl groups bonded to another straight-chain or branched alkyl group. Examples include (CH₃)₃SiCH₂ and t-Bu(CH₃)₂ SiCH₂CH(CH₃)CH₂.

The total number of carbon atoms in a substituent group is indicated by the “Cᵢ-Cⱼ” prefix where i and j are numbers from 1 to 10. For example, C₁-C₃ alkylsulfonyl designates methylsulfonyl through propylsulfonyl; C₂ alkoxyalkoxy designates CH₃OCH₂O; C₃ alkoxyalkoxy designates, for example, CH₃OCH₂CH₂O or CH₃CH₂OCH₂O; and C₄ alkoxyalkoxy designates the various isomers of an alkoxy group substituted with a second alkoxy group containing a total of 4 carbon atoms, examples including CH₃CH₂CH₂OCH₂O, and CH₃CH₂OCH₂CH₂O. Examples of “alkoxyalkyl”include CH₃OCH₂, CH₃OCH₂CH₂, CH₃CH₂OCH₂, CH₃CH₂CH₂CH₂OCH₂ and CH₃CH₂OCH₂CH₂.

Amino acid chains are from N-terminus to C-terminus. Furthermore, in the formulae, the R₁(C═O)— group is bound to the alpha nitrogen of the N-terminal amino acid of the peptide. The —NH₂ group (Formula I) or the —NH—R₂ group (Formula II) is bound to the carbon of the alpha carboxyl group of the C-terminal amino acid.

Preferably R₁ comprises from about 5 to about 15 carbon atoms, and more preferably comprises from about 6 to about 11 carbon atoms. Preferably R₁ comprises an alkyl group having from about 1 to about 20 carbon atoms. Preferably the alkyl group comprises from about 5 to about 15 carbon atoms, and more preferably comprises from about 6 to about 11 carbon atoms.

Preferably R₂ comprises 5 to 15 carbon atoms, and more preferably from about 6 to about 11 carbon atoms. Preferably, R₂ comprises an alkyl group. When R₂ is an alkyl group, preferably R₂ comprises from about 5 to about 15 carbon atoms, and more preferably from about 6 to about 11 carbon atoms.

The peptides of the peptide composition of the present invention may comprise residues from any of the naturally-occurring amino acids, or from non-naturally-occurring amino acids. These naturally-occurring and non-naturally-occurring amino acids may be in the D or L configuration. The terms D and L are used herein as they are known to be used in the art.

The standard single letter and three letter codes for amino acids are used herein and are as follows:

| | | |
|---|---|---|
| A (Ala) Alanine | C (Cys) Cysteine | D (Asp) Aspartic acid |
| E (Glu) Glutamic acid | F (Phe) Phenylalanine | G (Gly) Glycine |
| H (His) Histidine | I (Ile) Isoleucine | K (Lys) Lysine |
| L (Leu) Leucine | M (Met) Methionine | N (Asn) Asparagine |
| P (Pro) Proline | Q (Gln) Glutamine | R (Arg) Arginine |
| S (Ser) Serine | T (Thr) Threonine | V (Val) Valine |
| W (Trp) Tryptophan | Y (Tyr) Tyrosine | |

The amino acids of the peptides of the present invention may also be modified. The carboxyl group on the C-terminal end of the peptide may be esterified with an alkyl, substituted alkyl, alkene, substituted alkene, alkyne, substituted alkyne or with an aryl group (including heterocycles and polynuclear aromatic compounds). Carboxyl groups may be amidated. Carboxyl groups may also be reduced to alcohols, and potentially further converted to alkyl or alkyl halide ethers. Amino groups may be acylated, alkylated or arylated. Benzyl groups may be halogenated, nitrosylated, alkylated, sulfonated or acylated. These modifications are meant to be illustrative and not comprehensive of the types of modifications possible. Modification of the amino acids would likely add to the cost of synthesis and therefore is not preferred.

The peptide compositions of the present invention comprise peptides with antimicrobial activity. Peptides of the present invention are peptides having from about 1 to 10, preferably from about 1 to 7, and most preferably from about 1 to 6 amino acid residues.

The peptides of the present invention comprise at least one amino acid residue, whereby the composition can be expressed by Xₙ where n=1 to 10. Thus, peptides according to the present invention can be represented by:

X₁

X₁ X₂

X₁ X₂ X₃

X₁ X₂ X₃ X₄

X₁ X₂ X₃ X₄ X₅

X₁ X₂ X₃ X₄ X₅ X₆

X₁ X₂ X₃ X₄ X₅ X₆ X₇

X₁ X₂ X₃ X₄ X₅ X₆ X₇ X₈

X₁ X₂ X₃ X₄ X₅ X₆ X₇ X₈ X₉

X₁ X₂ X₃ X₄ X₅ X₆ X₇ X₈ X₉ X₁₀

The peptides according to the present invention include cationic and uncharged amino acids. For peptides of one to three amino acids (n=1-3), one amino acid in positions X₁, X₂ or X₃ is preferably a cationic amino acid, such that the net charge of the peptide at neutral pH is at least +1. The net positive charge for the peptides of the present invention is determined by summing the charges of each of the amino acids. The cationic amino acids may include arginine (Arg), lysine (Lys), ornithine (Orn) or histidine (His).

Preferably, the cationic amino acids are Arg, Lys or Orn; the most preferred amino acid is arginine. The remaining amino acids include all amino acids, preferably not negatively charged amino acids such as Glutamate (Glu) or Aspartate (Asp). The remaining amino acids may include phenylalanine (Phe), tryptophan (Trp), tyrosine (Tyr), alanine (Ala), glycine (Gly), isoleucine (Ile), leucine (Leu), proline (Pro), valine (Val), cysteine (Cys), methionine (Met), serine (Ser), threonine (Thr), asparagine (Asn), glutamine (Gln), 2-naphthylalanine (Nal), Arg, Lys, Orn or His.

For reasons facilitating manufacture, peptides of the present invention comprise preferably one or two, or possibly three amino acids. However, longer peptides may demonstrate increased efficacy. Thus, for peptides of four or five amino acids (n=4-5), at least two of the amino acids in positions X₁ through X₅ are preferably cationic amino acids such as Arg, Lys or Orn; Arg is the preferred amino acid. The remaining amino acids may comprise any amino acid, preferably not Glu or Asp; the net charge of the peptide at neutral pH is preferably at least +2.

For peptides of six to eight amino acids (n=6-8), it is prefered that at least three of the amino acids in positions X₁ through X₈ are cationic amino acids such as Arg, Lys or Orn; Arg is the preferred amino acid. The remaining amino acids may comprise any amino acid, preferably not Glu or Asp; the net charge of the peptide at neutral pH is preferably at least +3. When the peptide is an N-terminally hydrocarbyl-modified hexapeptide with a C-terminal amido group, the peptides of the invention are not Phe-Arg-Trp-Trp-His-Xaa (SEQ ID NO:24), Arg-Arg-Trp-Trp-Met-Xaa (SEQ ID NO:25), Arg-Arg-Trp-Trp-Cys-Xaa (SEQ ID NO:26), or Arg-Arg-Trp-Trp-Arg-Xaa (SEQ ID NO:27), where “Xaa” refers to any amino acid. When the peptide is an N-terminally hydrocarbyl-modified heptapeptide with a C-terminal amido group, the peptides of the invention are not Arg-Arg-Trp-Trp-Cys-Xaa-Xaa (SEQ ID NO:28), where “Xaa” refers to any amino acid.

For peptides of nine to ten amino acids (n=9-10), it is prefered that at least four of the amino acids in positions X₁ through X₁₀ are cationic amino acids such as Arg, Lys or Orn; Arg is the preferred amino acid. The remaining amino acids may comprise any amino acid, preferably not Glu or Asp; the net charge of the peptide at neutral pH is preferably at least +4.

Further, for peptides which are modified with a single hydrocarbyl group (Formula I), when n=2, it is prefered that one amino acid is a cationic amino acid such as Arg, Lys or Orn. The remaining amino acid may be any amino acid, preferably not Glu or Asp; the amino acid may include Phe, Trp, Tyr, Ala, Gly, Ile, Leu, Pro, Val, Cys, Met, Ser, Thr, Asn, Gln, Nal, Arg, Lys, Orn or His. The most preferred amino acid is Trp.

In addition, for peptides of three amino acids that are modified with a single hydrocarbyl group, it is prefered that at least one amino acid in positions X₁, X₂ or X₃ is a cationic amino acid such as Arg, Lys, or Orn. Further, it is prefered that at least one amino acid in positions X₁, X₂ or X₃ is Trp. The remaining amino acid may include any amino acid, preferably not Glu or Asp, however, the net charge of the peptide at neutral pH is preferably at least +1.

In addition, for peptides of four or five amino acids which are modified with a single hydrocarbyl group, it is preferable that at least two amino acids in positions X₁ through X₅ are cationic amino acids such as Arg, Lys, or Orn. Further, it is prefered that at least one amino acid in positions X₁ through X₅ is Trp. The remaining amino acid may include any amino acid, preferably not Glu or Asp, however, the net charge of the peptide at neutral pH is preferably at least +2.

In addition, for peptides of six to eight amino acids which are modified with a single hydrocarbyl group, it is prefered that at least three amino acids in positions X₁ through X₈ are cationic amino acids such as Arg, Lys, or Orn. Further, it is prefered that least two amino acids in positions X₁ through X₈ are Trp. The remaining amino acids may include any amino acid, preferably not Glu or Asp, however, the net charge of the peptide at neutral pH is preferably at least +3.

In addition, for peptides of nine to ten amino acids that are modified with a single hydrocarbyl group, it is prefered that at least four amino acids in positions X₁ through X₁₀ are cationic amino acids such as Arg, Lys, or Orn. Further, it is prefered that at least three amino acids in positions X₁ through X₁₀ are Trp. The remaining amino acids may include any amino acid, preferably not Glu or Asp, however, the net charge of the peptide at neutral pH is preferably at least +4.

Examples of less preferred peptides, except for those peptides modified with two hydrocarbyl groups, comprise peptides having at least 5 to 10 amino acid residues.

This preference is based upon economical factors in the manufacturing process.

Preferred peptides of the present invention (except for those modified with two hydrocarbyl groups) include:

| | |
|---|---|
| Arg-Phe-Arg | Lys-Phe-Arg |
| Lys-Phe-Lys | Arg-Phe-Lys |
| Orn-Phe-Arg | Orn-Phe-Orn |
| Arg-Phe-Orn | |
| Arg-Trp-Phe-Arg (SEQ ID NO: 1) | Arg-Trp-Arg-Phe (SEQ ID NO: 2) |
| Arg-Trp-Trp-Arg (SEQ ID NO: 3) | Arg-Arg-Trp-Phe (SEQ ID NO: 4) |
| Arg-Trp-Arg-Trp (SEQ ID NO: 5) | Arg-Phe-Arg-Trp (SEQ ID NO: 6) |
| Arg-Arg-Phe-Trp (SEQ ID NO: 7) | Arg-Trp-Ala-Arg (SEQ TD NO: 8) |
| Arg-Trp-Tyr-Arg (SEQ ID NO: 9) | Arg-Trp-Ile-Arg (SEQ ID NO: 1O) |
| Arg-Trp-Leu-Arg (SEQ ID NO: 11) | Arg-Trp-Pro-Arg (SEQ ID NO: 12) |
| Arg-Trp-Val-Arg (SEQ ID NO: 13) | Arg-Trp-Cys-Arg (SEQ ID NO: |
| | 14) |
| Arg-Trp-Met-Arg (SEQ ID NO: 15) | Arg-Trp-Ser-Arg (SEQ ID NO: 16) |
| Arg-Trp-Thr-Arg (SEQ ID NO: 17) | Arg-Trp-Asn-Arg (SEQ ID NO: |
| | 18) |
| Arg-Trp-Gln-Arg (SEQ ID NO: 19) | Arg-Trp-Nal-Arg (SEQ ID NO: |
| | 20) |
| Arg-Trp-His-Arg (SEQ ID NO: 21) | Arg-Trp-Lys-Arg (SEQ ID NO: |
| | 22) |
| Arg-Trp-Gly-Arg (SEQ ID NO: 23) | |

The most preferred peptides of the present invention (except those modified with two hydrocarbyl groups) are short peptides including:

| | |
|---|---|
| Arg-Trp | Lys-Trp |
| Orn-Trp | Arg-Trp-Phe |
| Lys-Trp-Phe | Orn-Trp-Phe |
| Arg-Trp-Cys | Lys-Trp-Cys |
| Orn-Trp-Cys | Arg-Phe-Trp |
| Lys-Phe-Trp | Orn-Phe-Trp |
| Arg-Arg-Trp | Lys-Lys-Trp |
| Lys-Arg-Trp | Arg-Lys-Trp |
| Orn-Orn-Trp | Orn-Arg-Trp |
| Arg-Orn-Trp | Arg-Trp-Arg |
| Lys-Trp-Arg | Arg-Trp-Lys |
| Lys-Trp-Lys | Orn-Trp-Arg |
| Arg-Trp-Orn | Orn-Trp-Orn |

Still further, for peptides modified with two hydrocarbyl groups, when n=1, the amino acid in position X₁ is preferably a cationic amino acid such as Arg, Lys or Orn. Arginine is the preferred amino acid.

In addition, for peptides which are two amino acids in length and which are modified with two hydrocarbyl groups, it is prefered that at least one amino acid in positions X₁ and X₂ is a cationic amino acid such as Arg, Lys or Orn. The remaining amino acid may include any amino acid, preferably not Glu or Asp; the amino acid may include Phe, Trp, Tyr, Ala, Gly, Ile, Leu, Pro, Val, Cys, Met, Ser, Thr, Asn, Gln, Nal, Arg, Lys, Orn or His. The net positive charge of the peptide at neutral pH is preferably at least +1.

In addition, for peptides which are three amino acids in length and which are modified with two hydrocarbyl groups, it is prefered that at least one amino acid in positions X₁, X₂ or X₃ is a cationic amino acid such as Arg, Lys or Orn. The remaining amino acids may include any amino acid, preferably not Glu or Asp; the amino acid may include Phe, Trp, Tyr, Ala, Gly, Ile, Leu, Pro, Val, Cys, Met, Ser, Thr, Asn, Gln, Nal, Arg, Lys, Orn or His. Preferably two of the amino acids are cationic amino acids, preferably the cationic amino acids are Arg. The net positive charge of the peptide at neutral pH is preferably at least +1.

In addition, for peptides which are four amino acids in length and which are modified with two hydrocarbyl groups, it is prefered that at least two amino acids in positions X₁, X₂, X₃ or X₄ are cationic amino acids such as Arg, Lys or Orn. The remaining amino acids may include any amino acid, preferably not Glu or Asp; the amino acids may include Phe, Trp, Tyr, Ala, Gly, Ile, Leu, Pro, Val, Cys, Met, Ser, Thr, Asn, Gln, Nal, Arg, Lys, Orn or His. The net positive charge of the peptide at neutral pH is preferably at least +2.

In addition, for peptides which are five to seven amino acids in length and which are modified with two hydrocarbyl groups, it is prefered that at least three amino acids in positions X₁ through X₇ are cationic amino acids such as Arg, Lys or Orn. The remaining amino acids may include any amino acid, preferably not Glu or Asp; the amino acids may include Phe, Trp, Tyr, Ala, Gly, Ile, Leu, Pro, Val, Cys, Met, Ser, Thr, Asn, Gln, Nal, Arg, Lys, Orn or His. The net positive charge of the peptide at neutral pH is preferably at least +3.

In addition, for peptides which are eight to ten amino acids in length and which are modified with two hydrocarbyl groups, it is prefered that at least four amino acids in positions X₁ through X₁₀ are cationic amino acids such as Arg, Lys or Orn. The remaining amino acids may include any amino acid, preferably not Glu or Asp; the amino acids may include Phe, Trp, Tyr, Ala, Gly, Ile, Leu, Pro, Val, Cys, Met, Ser, Thr, Asn, Gln, Nal, Arg, Lys, Orn or His. The net positive charge of the peptide at neutral pH is preferably at least +4.

Examples of less preferred peptides except for those peptides modified with a single hydrocarbyl group (which are described above) comprise peptides having at least 5 to 10 amino acid residues. This preference is based upon economical factors in the manufacturing process.

Preferred peptides of the present invention (except for those modified with a single hydrocarbyl group) include:

| | |
|---|---|
| Arg-Arg-Arg | Arg-Phe-Arg |
| Arg-Tyr-Arg | Arg-Ala-Arg |
| Arg-Ile-Arg | Arg-Leu-Arg |
| Arg-Pro-Arg | Arg-Val-Arg |
| Arg-Cys-Arg | Arg-Met-Arg |
| Arg-Ser-Arg | Arg-Thr-Arg |
| Arg-Asn-Arg | Arg-Gln-Arg |
| Arg-Nal-Arg | Arg-Orn-Arg |
| Arg-His-Arg | Arg-Lys-Arg |
| Arg-Gly-Arg | Arg-Arg-Nal |
| Arg-Arg-Phe | Arg-Arg-Tyr |
| Arg-Arg-Ala | Arg-Arg-Ile |
| Arg-Arg-Leu | Arg-Arg-Pro |
| Arg-Arg-Val | Arg-Arg-Cys |
| Arg-Arg-Met | Arg-Arg-Ser |
| Arg-Arg-Thr | Arg-Arg-Asn |
| Arg-Arg-Gln | Arg-Arg-Lys |
| Arg-Arg-His | Arg-Arg-Orn |
| Arg-Arg-Gly | |

The most preferred peptides of the present invention (except those modified with a single hydrocarbyl group) are short peptides including:

| | | |
|---|---|---|
| Arg | Lys | Orn |
| Arg-Arg | | Arg-Phe |
| Arg-Tyr | | Arg-Ala |
| Arg-Ile | | Arg-Leu |
| Arg-Pro | | Arg-Val |
| Arg-Cys | | Arg-Met |
| Arg-Ser | | Arg-Thr |
| Arg-Asn | | Arg-Gln |
| Arg-Nal | | Arg-His |
| Arg-Gly | | Phe-Arg |
| Tyr-Arg | | Ala-Arg |
| Ile-Arg | | Leu-Arg |
| Pro-Arg | | Val-Arg |
| Cys-Arg | | Met-Arg |
| Ser-Arg | | Thr-Arg |
| Asn-Arg | | Gln-Arg |
| Nal-Arg | | His-Arg |
| Gly-Arg | | |

The peptides of the present invention can be synthesized in any manner known in the art. The methods of synthesis may include, but are not limited to, solid-phase, aqueous phase, enzymatic or recombinant processes.

The peptide of the present invention may be synthesized by solid-phase synthesis as described originally by Merrifield in pages 2149-2154 of J. Amer. Chem. Soc., vol. 85, 1963, and may be modified according to Peptides: Synthesis, Structures and Applications, Gutte B. (ed.), Academic Press, NY, 1995, and Chemical Approaches to the Synthesis of Peptides and Proteins, Lloyd-Williams P., Alberico F., Giralt E. (eds.), CRC Press, NY, 1997. Generally, the C-terminal amino acid (with protected N-terminus) is attached to an appropriate solid support via the α-carboxyl group. The N-terminus is protected by an appropriate protecting group (such as tert-butyloxycarbonyl [Boc] or 9-fluorenylmethoxycarbonyl [Fmoc]). An example of a resin is a copolymer of styrene and 1% divinylbenzene. The Nα-protecting group is removed, and the amino acid that is N-terminal to the attached amino acid is coupled to the attached amino acid using appropriate coupling reagents (such as dicyclohexylcarbodiimide). The peptide is elongated by repeating the deprotection and coupling steps. When all of the amino acids have been added, side-chain protecting groups used during the synthesis are removed, and the peptide is cleaved from the resin. An acyl chain may be attached by a condensation reaction with the Nα-amide of the N-terminal amino acid of a peptide or to the C-terminal amide of the peptide. The acyl chain is added after removal of the Fmoc-group and prior to side chain deprotection. Acetic anhydride may also be used for N-terminal acetylation. For a C-terminal amide, an appropriate amide-containing resin is chosen such that when the peptide is cleaved from the resin, the amide group is retained on the peptide. Common solid supports for the synthesis of peptide amides are benzhydrylamide derivatives, such as 4-methylbenzhydrylamine resin. The peptide amide can be cleaved from the resin using hydrogen fluoride.

The peptides can be synthesized individually using an automated synthesizer or using a parallel synthesis approach, such as the tea bag method of simultaneously synthesizing equimolar amounts of multiple peptides as described in U.S. Pat. No. 5,504,190. Other methods of solid-phase synthesis known in the art may also be used to synthesize the peptides of the present invention.

The peptide of the present invention may be synthesized by solution-phase synthesis according to Chemical Approaches to the Synthesis of Peptides and Proteins, Lloyd-Williams P., Alberico F., Giralt E. (eds.), CRC Press, NY, 1997. Amino acids are protected and coupled using methods similar to that used for solid-phase synthesis, except that the C-terminus of the C-terminal amino acid must also be protected (common C-terminal protecting groups are alkyl and aryl esters). The coupling reagents may be chemicals such as dicyclohexylcarbodiimide or enzymes such as those supplied by Altus Biologics Inc. (Cambridge, Mass.).

The peptide of the present invention may be synthesized by recombinant synthesis. An oligonucleotide is synthesized using a DNA synthesizer. The sequence of the oligonucleotide encodes the amino acid sequence of the peptide and the codon usage is determined by the organism into which the DNA probe will be cloned. The DNA is then cloned into an appropriate expression vector, which is then introduced into a host organism for expression of the cloned sequence and production (or overproduction) of the peptide. The host organism may be a microorganism such as a bacterium or fungus, virus or bacteriophage, plant or animal. The peptide may be made as a fusion protein to facilitate expression/production or aid in peptide delivery to target. Following purification of the peptide, N- and/or C-terminal hydrocarbyl groups may be added by appropriate methods.

The peptides of the present invention may be purified by conventional liquid chromatographic methods known in the art. These include the use of gel filtration and reverse-phase chromatography.

Without further elaboration, it is believed that one skilled in the art can, using the preceding description, utilize the present invention to its fullest extent.

The following provides examples of the invention. Examples 1-2 are actual examples. Examples 3-17 are prophetic. These examples are merely illustrative of the invention and are not intended to limit the scope of the disclosure or any claim.

### EXAMPLES

### Example 1

### Materials and Methods of Peptide Synthesis and Bacterial Assays

Synthesis of Peptides

The peptides of the present invention may be synthesized via solid-phase synthesis according to the methods discussed above.

Antimicrobial Assays

Cultures are grown for 19 h in an incubator shaker (200 rpm; Model G-25, New Brunswick Scientific, Edison, N.J.). The cultures are subjected to centrifugation (20 min, 22 C, 2890×g, Labofuge A, American Scientific Products, Houston, Tex.) and resuspension in Wilson's Salts solution (see below). The assays are performed in 96-well “U”-bottom microtiter plates (Dynatech Laboratories, Inc., Chantilly, Va.) in a total volume of 100 μl. The assay mixture (final concentration) consists of 0.5×medium, peptide at concentrations of 0 to 500 μg/ml in H₂O, and inoculum (2.5×10⁵ cells/ml).

The plates are incubated for 18, 24 or 48 h, and growth of the organisms are determined by measuring the change in optical density at 540 nm (Spectramax 250, Molecular Devices, Sunnyvale, Calif.). The minimum inhibitory concentration (MIC) is calculated from the concentration of peptide to inhibit growth by >90%.

Strains and Media

The strains, growth media and incubation temperatures used are as follows:

| | | |
|---|---|---|
| Burkholderia cepacia ATCC 25416 | 0.5X mTGE | 30° C. |
| Candida albicans ATCC 10231 | Sabouraud Dextrose | 30° C. |
| Escherichia coli ATCC 25922 | 0.5X mTGE | 37° C. |
| Klebsiella pneumoniae ATCC 10031 | 0.5X mTGE | 37° C. |
| Pseudomonas aeruginosa ATCC 10145 | 0.5X mTGE | 37° C. |
| Pseudomonas aeruginosa ATCC 27853 | 0.5X mTGE | 37° C. |
| Pseudomonas aeruginosa FRD1 | 0.5X mTGE | 30° C. |
| (G. Sayler, U. Tennessee) | | |
| Saccharomyces cerevisiae ATCC9763 | YM | 30° C. |
| Staphylococcus aureus ATCC 29213 | Nutrient | 37° C. |

mTGE Broth, Nutrient Broth, YM and Sabouraud Dextrose Broth are obtained from Difco (Detroit, Mich.). Wilson's Salts solution (pH 7.0) contains (g/l): K₂HPO₄, 3.0; KH₂PO₄, 1.5; MgSO₄.7H₂O, 0.1; (NH₄)₂SO₄, 1.0. Triclosan (Irgasan® DP300) is obtained from Ciba Specialty Chemicals Corporation (High Point, N.C.). The peptides tested each dissolve in H₂O or in 5% DMSO/95% H₂O. In all experiments, the peptides are added at concentrations which are non-toxic to the test organisms; the following concentrations are used:

Peptide at 4-6 μg/ml against test organisms.

The biocide actives and formulations tested are as follows:

Biocides:

DGH: dodecylguanidine hydrochloride, 33%

MBT: methylene bis(thiocyanate)

Maquat: n-alkyl (C12-40%, C14-50%, C16-10%) dimethylbenzylammonium chloride, 80%

Aqucar: glutaraldehyde, 45%

7287: 2,2-dibromo-3-nitrilo propionamide (DBNPA), 20%

Kathon: 5-chloro-2-methyl-4-isothiazolin-3-one, 12%; 2-methyl-4-isothiazolin-3-one, 3%

Myacide: 2-bromo-2-nitropropane-1,3-diol (Bronopol), 95%

Biocide Formulations:

508: DBNPA, 20%; Kathon, 0.6%

C-31: DGH, 10%; MBT, 5%

C-41A: β-bromo-β-nitrostyrene (BNS), 9.2% (based on 25% solution of BNS);

MBT, 4.9%

C-68: Kathon, 1.5%

C-74: DGH, 5%; Maquat, 8%

BT91-W: Bronopol, 5%; Kathon, 1.9%

BT97-W: Bronopol, 5.3%; Maquat, 8%

The MIC's (μg/ml) for biocide actives and biocide formulations are as follows:

| | K. pneumoniae | P. aeruginosa |
|---|---|---|
| Biocide Active | | |
| DGH | 2.5 | 10.0 |
| MBT | 0.6 | 0.6 |
| Maquat | 0.6 | 7.8 |
| Aqucar | 250.0 | 500.0 |
| 7287 | 40.0 | 40.0 |
| Kathon | 2.5 | 2.5 |
| Myacide | 10.0 | 1.3 |
| Biocide Formulations | | |
| 508 | 50.0 | 50.0 |
| C-31 | 6.3 | 12.5 |
| C-41A | 12.5 | 12.5 |
| C-68 | 12.5 | 25.0 |
| C-74 | 12.5 | 50.0 |
| BT91-W | 6.3 | 12.5 |
| BT97-W | 12.5 | 25.0 |

### Example 2

### Effect of Combinations of Triclosan and Sub-biocidal Levels of Peptide on Microbial Growth

In this experiment, octanoyl-R—NH-octyl and octanoyl-RR—NH-octyl were used as model peptides. The experiments were performed as described in Example 1; the strains, growth media and incubation temperatures were as follows:

| | | |
|---|---|---|
| Candida albicans ATCC 10231 | YM | 30° C. |
| Escherichia coli ATCC 25922 | 0.5X mTGE | 37° C. |
| Klebsiella pneumoniae ATCC 27736 | 0.5X mTGE | 37° C. |
| Pseudomonas aeruginosa ATCC 10145 | 0.5X mTGE | 37° C. |
| Saccharomyces cerevisiae ATCC 9763 | YM | 30° C. |
| Staphylococcus aureus ATCC 33591 (MRSA) | Nutrient | 37° C. |

The addition of sub-biocidal amounts of peptide substantially increased the inhibitory effect of triclosan against all organisms tested except P. aeruginosa. Thus, the potential use rate of triclosan as an antimicrobial is reduced. The results of this example are shown in Table 1.

Triclosan plus peptide vs. clinically and industrially relevant organisms

| | | Peptide | Triclosan | Triclosan plus |
|---|---|---|---|---|
| | | MIC | MIC | constant [peptide] |
| Organism | Peptide | (μg/ml) | (μg/ml) | (μg/ml)^{a} |
| K. | octanoyl-RR- | 4 | 0.061 | 0.00003 (1 ppm) |
| pneumoniae | NH-octyl | | | |
| ATCC | | | | |
| 27736 | | | | |
| K. | octanoyl-RR- | 4 | 0.061 | 0.031 (0.5 ppm) |
| pneumoniae | NH-octyl | | | |
| ATCC | | | | |
| 27736 | | | | |
| P. | octanoyl-R- | 8 | >250 | >250 (4 ppm) |
| aeruginosa | NH-octyl | | | |
| ATCC | | | | |
| 10145 | | | | |
| C. albicans | octanoyl-RR- | 8 | 8 | 2 (4 ppm) |
| ATCC | NH-octyl | | | |
| 10231 | | | | |
| C. albicans | octanoyl-RR- | 8 | 8 | 4 (2 ppm) |
| ATCC | NH-octyl | | | |
| 10231 | | | | |
| E. coli | octanoyl-R- | 8 | 0.002 | <0.00003 (4 ppm) |
| ATCC | NH-octyl | | | |
| 25922 | | | | |
| S. cerevisiae | octanoyl-R- | 8 | 4 | 2 (2 ppm) |
| ATCC 9763 | NH-octyl | | | |
| S. aureus | octanoyl-RR- | 2 | 0.015 | 0.002 (0.5 ppm) |
| ATCC | NH-octyl | | | |
| 33591 | | | | |
| (MRSA) | | | | |

^{a}Values in parentheses refer to the concentrations of peptide used

### Example 3

### The Efficacy of a Peptide Composition Comprising a Chemically-modified Peptide of the Invention and at least One Biocide or Germicide is Demonstrated Against Fungi

Aspergillus niger (ATCC 16888) is grown at 30° C. on V-8 Juice Agar which contains 200 ml of V-8 juice, 3 g of CaCO₃, 15 g of agar and tap water to 1000 ml (pH 7.2). The medium is sterilized and poured into 75 cm² vented cell culture flasks (Coming Incorporated, Corning, N.Y.; 30 ml per flask). Spores are harvested by washing the culture with 5 ml of Wilson's Salts Solution and diluting to 9.4×10⁴ spores/ml (spore number is determined by plating spores onto Yeast Mold Film 3M, St. Paul, Minn.). The assays are performed in 96 well “U”-bottom microtiter plates. The assay mixture consists of 0.5×medium (2×Sabouraud Dextrose Broth [Difco, Detroit, Mich.]), peptide at concentrations of 0 to 500 μg/ml in H₂O and spores (2.35×10⁴ spores/ml). The plates are incubated for 22 h at 37° C. Growth is determined by measuring the change in optical density at 540 nm. The effect of a peptide composition comprising (indicate peptide) and at least one biocide or germicide is determined by growth of A. niger. The efficacy of the peptide in combination with the biocide or germicide is greater than with peptide or Biocide/germicide alone.

### Example 4

Antibiofouling compositions for water treatment comprise acyl-modified peptides from about 0.001% to about 50% by weight of the total composition. Other components in the antibiofouling compositions (used at 0.1% to 50%) may include:

2-bromo-2-nitropropane-1,3-diol (BNPD)

β-bromo-β-nitrostyrene (BNS)

dodecylguanidine hydrochloride

2,2-dibromo-3-nitrilopropionamide (DBNPA)

glutaraldehyde

isothiazolin

methylene bis(thiocyanate)

triazines n-alkyl dimethylbenzylammonium chloride

trisodium phosphate-based antimicrobials

tributyltin oxide

oxazolidines

tetrakis (hydroxymethyl) phosphonium sulfate (THPS)

phenols

chromated copper arsenate

zinc or copper pyrithione

carbamates

sodium or calcium hypochlorite

sodium bromide

halohydantoins (Br, Cl)

Chlorine rates are based on achieving the appropriate concentration of free halogen. Other components in the composition may include biodispersants (about 0.1% to about 15% by weight of the total composition), water, glycols (about 20-30%) or Pluronic (at approximately 7% by weight of the total composition). The concentration of antibiofouling composition for continuous or semi-continuous use is about 5 to about 70 mg/l.

### Example 5

Antibiofouling compositions for industrial water treatment comprise acyl-modified peptides from about 0.001% to about 50% by weight of peptide based on the weight of the total composition. The amount of acyl-modified peptide in antibiofouling compositions for aqueous water treatment may be adjusted depending on the particular peptide and aqueous environment. Shock dose ranges are generally about 20 to about 140 mg/l; the concentration for semi-continuous use is about 0.5× of these concentrations.

| | |
|---|---|
| Octanoyl-RR-NH-octyl | 0.01-5.0% |
| Glutaraldehyde | 45% |
| Water | 50-55% |

### Example 6

Examples of antimicrobial compositions for use as household products include:

| A. Powder Automatic Dishwashing Composition | |
|---|---|
| Octanoyl-Arg-Phe-Phe-Arg-NH-octyl | 0.00001-50% |
| Antimicrobial | 0.0001-10% |
| nonioinic surfactant | 0.4-2.5% |
| sodium metasilicate | 0-20% |
| sodium disilicate | 3-20% |
| sodium triphosphate | 20-40% |
| sodium carbonate | 0-20% |
| sodium perborate | 2-9% |
| tetraacetylethylenediamine | 1-4% |
| sodium sulphate | 5-33% |
| enzymes, including modified enzymes | 0.0001-0.5% |
| B. Non-aqueous Liquid Automatic Dishwashing | |
| Composition | |
| decanoyl-Arg-Trp-Phe-NH₂ | 0.00001-50% |
| antimicrobial | 0.0001-10% |
| liquid nonionic surfactant | 2-10% |
| alkali metal silicate | 3-15% |
| alkali metal phosphate | 20-40% |
| liquid carrier selected from higher | 25-45% |
| glycols, polyglycols, polyoxides, | |
| glycoethers | |
| stabilizer (partial ester of phosphoric | 0.5-7% |
| acid and a C₁₆-C₁₈ alkanol) | |
| foam suppressor (silicone) | 0-1.5% |
| enzymes, including modified enzymes | 0.0001-0.5% |
| C. Liquid Automatic Dishwashing Composition | |
| Hexanoyl-Arg-Trp-Phe-NH₂ | 0.00001-50% |
| Antimicrobial | 0.0001-10% |
| fatty acid ester sulphonate | 0-30% |
| sodium dodecyl sulphate | 0-20% |
| alkyl polyglycoside | 0-21% |
| oleic acid | 0-10% |
| sodium disilicate monohydrate | 18-33% |
| sodium citrate dihydrate | 18-33% |
| sodium stearate | 0-2.5% |
| sodium perborate monohydrate | 0-13% |
| tetraacetylethylenediamine | 0-8% |
| maleic acid/acrylic acid copolymer | 4-8% |
| enzymes, including modified enzymes | 0.0001-0.5% |
| D. Laundry Detergent or Hard Surface Cleaner | |
| Octanoyl-Arg-Trp-NH₂ | 0.00001-50% |
| antimicrobial | 0.0001-10% |
| alkyl benzene sulfonic acid | 1-20% |
| sodium C12-15 alkyl sulfate | 0.5-5% |
| ethoxylated C14-15 alkyl sulfate | 0-15% |
| C12 glucose amide | 0-15% |
| ethoxylated C12-15 alcohol | 0-15% |
| fatty acid | 1-15% |
| citric acid | 2-15% |
| C₁₂₋₁₄ alkenyl substituted succinic | 0-15% |
| acid | |
| sodium hydroxide | 0.5-15% |
| ethanol | 1-10% |
| monoethanolamine | 0-10% |
| 1,2-propane diol | 2-10% |
| LipolaseR (100 KLU/g commercial solution) | 0-1% |

### Example 7

Examples of pharmaceutical compositions for prophylactic or therapeutic treatment include:

| A. For Vaginal Douches: | |
|---|---|
| Acetyl-Arg-Trp-Arg-Trp-NH₂ | 0.000001-20% |
| benzalkonium chloride, parabens or | 0-30% |
| chlorothymol (other antimicrobial agents) | |
| phenol or menthol (anesthetic or antipruritics) | 10-30% |
| potassium alum (astringent) | 0.4% or 4 g |
| zinc sulfate (astringent) | 0.4% or 4 g |
| liquefied phenol | 0.5-5% |
| glycerin | 10-15% |
| sodium lauryl sulfate (surface active agent) | 20-50% |
| sodium borate, sodium bicarbonate or citric acid | 10-15% |
| (pH altering chemicals) | |
| pyrogen-free, sterile water | qs to make 1000 ml |
| B. For Nasal Solutions | |
| Octanoyl-Arg-Trp-Phe-NH₂ | 0.000001-10% |
| Preservative | 0.0001-10% |
| chlorobutanol | 0.5-5% |
| sodium chloride | 0.5-5% |
| pyrogen-free, sterile water | qs to make 100 ml |
| C. Exilirs | |
| Octanoyl-Arg-NH-octyl | 0.000001-15% |
| preservative | 0.0001-10% |
| orange oil | 0.1-5% |
| benzaldehyde | 0.005-5% |
| sorbitol solution USP | 10-25% |
| propylene glycol | 40-60% |
| alcohol | 40-60% |
| pyrogen-free, sterile water | qs to make 100 ml |
| D. Otic Solutions | |
| Decanoyl-Arg-NH-decyl | 0.000001-10% |
| starch glycerin | 10-35% |
| benzoic acid or other preservative | 0.0001-10% |
| glycerin | 70% |
| pyrogen-free, sterile water | 20% |
| E. For Inhalations and Inhalants (Solutions) | |
| Decanoyl-Arg-Trp-Phe-NH₂ (solubilized) | 0.000001-25% |
| Preservative | 0.0001-10% |
| antioxidants (ex: ascorbic acid) | 0.5-10% |
| solvent blends (ex: water, ethanol, glycols) | 40-70% |
| propellants | 5-15% |
| F. For Inhalations and Inhalants (Suspensions) | |
| Nonanoyl-Arg-Trp-Phe-NH₂ | 0.000001-25% |
| (micronized & suspended) | |
| preservative | 0.0001-10% |
| dispersing agent (ex: sorbitan trioleate, | 40-50% |
| oleyl alcohol, oleic acid, lecithin) | |
| propellants | 5-20% |
| G. Liniments | |
| Heptanoyl-Arg-NH-heptyl | 0.000001-20% |
| Preservative | 0.0001-10% |
| ammonium chloride | 10-25% |
| dilute ammonia solution | 2-20% |
| oleic acid | 5-25% |
| turpentine oil | 15-35% |
| pyrogen-free, sterile water | 50-70% |
| H. For Water in Oil in Water Emulsion (W/O/W) | |
| Octanoyl-Arg-Ala-NH-octyl | 0.000001-20% |
| preservative | 0.0001-10% |
| isopropyl myristate | 30-60% |
| sorbitan monooleate | 1-10% |
| pyrogen-free, sterile water | qs to 100 ml |
| I. Oil in Water in Oil Emulsion (O/W/O) | |
| Nonanoyl-Arg-Arg-NH-nonyl | 0.000001-20% |
| Preservative | 0.0001-10% |
| soybean oil | 5-20% |
| ethanol | 10-35% |
| egg phosphatides | 0.5-10% |
| Myrj 52 (polyoxyethylene derivative of fatty acids) | 0.1-5% |
| pyrogen-free, sterile water | qs to 100 ml |
| J. Water in Oil Microemulsion (W/O) | |
| Octanoyl-Arg-Cys-NH-octyl | 0.000001-20% |
| preservative | 0.0001-10% |
| propylene glycol esters of capric/caprylic acids | 5-50% |
| polyoxyethylene (50) sorbitan esters | 8-20% |
| polyoxyethyleneglycerol triricinoleate | 8-20% |
| propylene glycol | 20-30% |
| K. Gels | |
| Octanoyl-Arg-Phe-NH-octyl | 0.00001-20% |
| Preservative | 0.0001-10% |
| sodium alginate (gelling agent) | 2-10% |
| glycerin | 2-10% |
| methyl hydroxybenzoate | 0.1-5% |
| pyrogen-free, sterile water | qs to 100 ml |
| L. Creme-Lotions | |
| Octanoyl-Arg-Trp-Cys-NH₂ | 0.01-15% |
| Preservative | 0.0001-10% |
| anhydrous lanolin | 15-40% |
| mineral oil | 5-35% |
| olive oil | 5-35% |
| ethyl alcohol | 5-35% |
| pyrogen-free, sterile water | 5-20% |
| glycerin | 5-20% |
| Tween 80 | 0.5-5% |
| Polyvinylpyrrolidone (PVP) | 0.5-5% |
| sodium dodecyl sulfate | 0.1-5% |
| M. Oleaginous Base Topical Formulations | |
| Octanoyl-Arg-Gly-NH-octyl | 0.01-5% |
| preservative | 0.0001-10% |
| anhydrous lanolin | 10-40% |
| mineral oil | 10-40% |
| olive oil | 10-40% |
| Tween 80 | 5-20% |
| N. Oleaginous Base Ointments | |
| Octanoyl-Arg-NH-CH₂-C₆H₅ | 0.01-10% |
| preservative | 0.0001-10% |
| anhydrous lanolin | 10-45% |
| white petrolatum | 10-45% |
| olive oil | 10-45% |
| Tween 80 | 5-35% |
| O. Intravenous Admixtures | |
| Octanoyl-Arg-His-NH-octyl | 0.000001-10% |
| preservative | 0.0001-10% |
| polyoxyethylene glycol monoester of saturated | 5-75% |
| hydroxylated fatty acid | |
| polyethylene glycol | 2-50 ml |
| 96% ethanol | qs 100 ml |
| solution diluted with isotonic saline, glucose, | |
| dextran, fructose or mannitol solution. | |
| P. Other Parenteral Admixtures | |
| Octanoyl-His-Arg-NH-octyl | 0.00001-10% |
| Preservative | 0.0001-10% |
| soybean oil | 5-35% |
| acetylated monoglycerides | 1-25% |
| egg yolk phosphatides | 0.1-10% |
| glycerol | 0.1-10% |
| pyrogen-free, sterile water | qs 100 ml |
| Q. Opthalmic Solutions | |
| Octanoyl-Arg-Trp-NH₂ | 0.000001-10% |
| Preservative | 0.0001-10% |
| sodium chloride USP | 0.5-10% |
| benzalkonium chloride | 1:10,000 |
| pyrogen-free, sterile water | qs 100 ml |
| R. Topical ointments | |
| Octanoyl-Arg-Leu-NH-octyl | 0.00001-20% |
| preservative | 0.0001-10% |
| methylparaben | 0.1-10 g |
| propylparaben | 0.1-10 g |
| sodium lauryl sulfate | 5-25% |
| propylene glycol | 5-25% |
| stearyl alcohol | 10-45% |
| white petrolatum | 10-45% |
| pyrogen-free, sterile water | 20-60% |
| S. Emulsion type topical solutions | |
| Octanoyl-Arg-NH-octyl | 0.0001-20% |
| Preservative | 0.0001-10% |
| transcutol | 5-45% |
| polyoxyethylene glycolated hydrogenated castor oil | 1-15% |
| transesterified triglyceride (Labrafil) | 5-35% |
| glycerol monostearate | 5-40% |
| white petrolatum | 20-60% |
| T. Space Spray | |
| Octanoyl-Arg-Trp-Phe-NH₂ | 2-20% |
| Preservative | 0.0001-10% |
| propellant | 70-98% |
| U. Surface-coating Spray | |
| Octanoyl-Arg-Gln-NH-octyl | 1-75% |
| preservative | 0.0001-10% |
| propellant | 15-99% |
| V. Foam Spray (edible) | |
| Octanoyl-Arg-Arg-NH-octyl | up to 50% |
| preservative | 0.0001-10% |
| vegetable oil (ex: peanut, cottonseed, soybean) | 40-90% |
| emulsifier (ex: glyceryl monostearate) | 1-10% |
| propellant (ex: propane) | 1-10% |
| W. Other foam Spray | |
| Octanoyl-Lys-NH-octyl | up to 50% |
| Preservative | 0.0001-10% |
| ethanol | 46-66% |
| surfactant (ex: nonionic, anionic or cationic) | 0.5-5% |
| pyrogen-free, sterile water | 28-42% |
| propellant (ex: propane) | 3-15% |
| X. Soft gelatin capsules | |
| Heptanoyl-Arg-NH-heptyl | 0.0001-15% |
| Preservative | 0.0001-10% |
| caprylic acid | 2-25% |
| capric acid | 2-25% |
| lauric acid | 5-50% |
| myristic acid | 2-25% |
| palmitic acid | 5-15% |
| stearic acid | 5-15% |
| monoacylglyceride | 5-50% |
| diacylglyceride | 5-40% |
| triacylglyceride | 5-60% |
| silicon dioxide | 0.05-3% |
| Y. Hard gelatin capsules | |
| Octanoyl-Arg-Trp-Phe-NH₂ | 0.0001-60% |
| Preservative | 0.0001-10% |
| stearate 1500 | 15-30% |
| Eudragit S 100 | 25-69% |

### Example 8

Examples of doses of pharmaceutical compositions comprising peptides of the present invention and at least one antimicrobial (from about 0.000002-5% by weight based on the total weight of the composition) include:

PEPTIDE CONCENTRATION

| | |
|---|---|
| A. Nebulizer | 5 to 200 mg/ml |
| B. Metered dose inhaler | 0.5 to 45 mg |
| C. Dry powder inhaler | 0.5 to 45 mg |
| D. Intramuscular, intravenous | 1 to 10 mg/kg |
| or intraperitoneal injection | |

### Example 9

Examples of diseases or infections treatable by pharmaceutical compositions comprising peptides of the present invention and at least one antimicrobial include:

| | DISEASES/ | |
|---|---|---|
| PEPTIDES | INFECTIONS | DOSE |
| Octanoyl-Arg-Trp-Phe-NH₂ | Cystic fibrosis | 0.5-45 mg (inhaler) |
| Nonanoyl-Arg-NH-nonyl | Periodontitis | 0.0001-1% |
| (mouth rinse) | | |
| Octanoyl-Arg-Trp-NH₂ | Urinary tract | 0.01-100 |
| | infection | (mg/kg, oral) |
| Decanoyl-Arg-NH-decyl | Otitis media | 0.000001-20% |
| (ear drops) | | |
| Decanoyl-Arg-Trp-Phe-NH₂ | Acne | 0.001-15% |
| (cream) | | |
| Nonanoyl-Arg-Trp-Phe-NH₂ | Gonorrhea | 0.01-100 |
| (mg/kg, oral) | | |
| Octanoyl-Arg-Ala-NH-octyl | Retinitis | 0.000001-5% |
| (eye drops) | | |
| Octanoyl-Arg-NH-octyl | Bronchitis | 0.01-100 |
| (mg/kg, oral) | | |
| Octanoyl-Arg-Cys-NH-octyl | Ulcer | 0.01-100 |
| (mg/kg, oral) | | |
| Nonanoyl-Arg-Arg-NH-octyl | Sinusitis | 0.01-100 |
| (mg/kg, oral) | | |
| Octanoyl-Arg-Phe-NH-octyl | Burn or wound | 0.000001-20% |
| infections (cream) | | |
| Octanoyl-Arg-NH-nonyl | Mononucleosis | 0.01-100 |
| (mg/kg, oral) | | |

### Example 10

Examples of hygiene compositions for personal care use comprising peptides of the present invention include:

| | |
|---|---|
| A. Facial Cleanser | |
| Octanoyl-Arg-Tyr-NH-octyl | 0.0001-20% |
| preservative or antimicrobial | 0.0001-10% |
| ammonium laureth sulfate | 28-32% |
| disodium EDTA | 0.01-0.1% |
| cocamidopropyl betaine | 6-9% |
| cocamidopropyl phosphatidyl PG-dimonium chloride | 1-3% |
| cocamide DEA | 1-3% |
| lactic acid | 0-3% |
| glycerin | 1-5% |
| propylene glycol, imidazolidinyl urea, methylparaben, | 0.5-1% |
| propylparaben | |
| pyrogen-free, sterile deionized water | 50-55% |
| sodium hydroxide | 0.5-10% |
| B. Cream | |
| Octanoyl-Arg-Gly-NH-octyl | 0.00001-15% |
| biocide or germicide | 0.0001-10% |
| behentrimonium methosulfate, cetearyl alcohol | 0.5-4% |
| Miglyol 840 | 5-10% |
| Arlacel 165 | 5-12% |
| phenyl trimethicone | 0.5-4% |
| glycerin | 0.5-6% |
| propylene glycol, diazolidinyl | 0.5-2% |
| urea, methylparaben, propylparaben | |
| xanthan gum | 0.05-2% |
| magnesium aluminum silicate | 0.05-5% |
| silica | 0.05-3% |
| Tween 60 | 0.05-2% |
| lactic acid | 1-20% |
| sodium hydroxide | 0.5-12% |
| cyclomethicone | 0.5-2% |
| pyrogen-free, sterile deionized water | 30-70% |
| C. Cream | |
| Octanoyl-Arg-Trp-Phe-NH₂ | 0.00001-15% |
| preservative or antimicrobial | 0.0001-10% |
| cetostearyl alcohol | 0.3-15% |
| hydrogenated lanolin | 0.5-15% |
| ethyl p-hydroxybenzoate | 0.03-5% |
| polyoxyethylene (20) sorbitan | 0.2-10% |
| monopalmitate | |
| glycerol monostearate | 0.2-10% |
| sodium N-stearoylglutamate | 0.05-5% |
| retinol acetate | 0.2-10% |
| perfume | 0.003-5% |
| 1,3-butylene glycol | 0.5-15% |
| polyethylene glycol 1500 | 0.5-15% |
| pyrogen-free, sterile deionized water | balance |
| D. Sun-screening Cream | |
| Octanoyl-Arg-His-NH-octyl | 0.00001-15% |
| preservative or antimicrobial | 0.0001-10% |
| decamethylcyclopentasiloxane | 3-50% |
| liquid paraffin | 0.5-15% |
| polyoxyalkylene-modified | 0.1-5% |
| organopolysiloxane | |
| distearyldimethylammonium chloride | 0.06-5% |
| perfume | 0.03-5% |
| titanium oxide | 1-25% |
| zinc oxide | 0.5-15% |
| talc | 0.2-15% |
| glycerin | 0.5-20% |
| magnesium aluminum silicate | 0.1-10% |
| pyrogen-free, sterile deionized water | balance |
| E. Lotion | |
| Nonanoyl-Arg-Trp-Phe-NH₂ | 0.00001-20% |
| preservative or antimicrobial | 0.0001-10% |
| magnesium aluminum silicate | 0.2-0.5% |
| xanthan gum | 0.1-0.3% |
| glyceryl stearate, PEG-100 stearate | 5-10% |
| Tween 60 | 0.5-2% |
| ceteareth alcohol | 0.5-2% |
| propylene glycol, diazolidinyl urea, | 0.5-2% |
| methylparaben, propylparaben | |
| glycerin | 2-6% |
| Miglyol 840 | 8-12% |
| phenyl trimethicone | 1-3% |
| cyclomethicone | 0.5-2% |
| lactic acid | 1-20% |
| sodium hydroxide | 0.5-13% |
| pyrogen-free, sterile deionized water | 35-38% |
| F. Clear Lotion | |
| Decanoyl-Arg-Trp-Phe-NH₂ | 0.00001-15% |
| preservative or antimicrobial | 0.0001-10% |
| tocopherol acetate | 0.001-5% |
| glycerin | 0.4-10% |
| 1,3-butylene glycol | 0.4-10 |
| ethanol | 0.8-15% |
| polyoxyethylene (60) hardened | 0.05-5% |
| castor oil | |
| methyl p-hydroxybenzoate | 0.02-5% |
| citric acid | 0.005-5% |
| sodium citrate | 0.01-5% |
| perfume | 0.005-5% |
| pyrogen-free, sterile deionized water | balance |
| G. Milky Lotion | |
| Octanoyl-Arg-Phe-Phe-Arg-NH-octyl | 0.00001-15% |
| preservative or antimicrobial | 0.0001-10% |
| stearic acid | 0.15-5% |
| cetyl alcohol | 0.05-5% |
| polyoxyethylene (10) monooleate | 0.2-10% |
| L-arginine | 0.03-6% |
| sodium L-glutamate | 0.002-5% |
| PCA-NA | 0.005-5% |
| 2-aminoethylthiosulfonic acid | 0.02-5% |
| 2-aminoethylsulfinic acid | 0.001-5% |
| propylene glycol | 0.5-10% |
| glycerin | 0.3-10% |
| ethanol | 0.3-10% |
| ethyl p-hydroxybenzoate | 0.03-3% |
| perfume | 0.003-3% |
| carboxyvinyl polymer | 0.01-5% |
| pyrogen-free, sterile deionized water | balance |
| H. Sun-screening Milky Lotion | |
| Octanoyl-Arg-Trp-NH₂ | 0.00001-15% |
| preservative or antimicrobial | 0.0001-10% |
| stearic acid | 0.2-5% |
| cetyl alcohol | 0.05-5% |
| liquid paraffin | 1-20% |
| polyoxyethylene (10) oleate | 0.1-5% |
| sorbitan trioleate | 0.1-5% |
| perfume | 0.02-2% |
| 1,3-butylene glycol | 0.5-5% |
| dipropylene glycol | 0.3-3% |
| carboxyvinyl polymer | 0.01-5% |
| trisodium edetate | 0.005-3% |
| triethanolamine | 0.04-5% |
| silica | 0.2-2% |
| talc | 0.2-2% |
| titanium oxide | 0.3-3% |
| zinc oxide | 0.3-3% |
| pyrogen-free, sterile deionized water | balance |
| I. Hair Conditioner | |
| Hexanoyl-Arg-Trp-Phe-NH₂ | 0.001-20% |
| Preservative | 0.0001-10% |
| pyrogen-free, sterile deionized water | 89-92% |
| dimethyl hydroxymethyl pyrazole | 0.5-5% |
| panthenol | 0.1-0.3% |
| disodium EDTA | 0.02-.1% |
| cetearyl alcohol, ceteareth-20 | 1-2% |
| stearyl alcohol | 4-6% |
| cetrimonium bromide | 4-6% |
| jojoba oil | 0.2-0.5% |
| acetamide MEA | 0.5-2% |
| lactamide MEA | 0.5-2% |
| J. Hair Shampoo | |
| Octanoyl-Arg-Phe-Phe-Arg-NH-octyl | 0.001-20% |
| preservative | 0.0001-10% |
| anionic surfactant | 5-15% |
| (polyoxyethylenealkyl sulfate) | |
| cationic surfactant | 0.5-2.5% |
| (distearyl dimethylammonium chloride) | |
| amphoteric surfactant | 5-15% |
| (alkylamine oxide) | |
| thickener | 0.5-15% |
| (isostearic acid diethanolamide) | |
| wetting agent (propylene glycol) | 1-20% |
| lower alcohol (ethanol) | 1-15% |
| perfume | proper amount |
| pyrogen-free, sterile deionized water | balance |
| K. Antiperspirant/Deodorant Solution | |
| Acetyl-Arg-Trp-Arg-Trp-NH₂ | 0.0001-20% |
| Preservative | 0.0001-10% |
| aluminum chlorohydrate | 10-40% |
| SD alcohol 40 | 25-35% |
| Transcutol ethoxydiglycol | 5-10% |
| Tween 20 | 0.5-1% |
| cocamidopropyl phosphatidyl PG- | 1-2% |
| dimonium chloride | |
| pyrogen-free, sterile deionized water | 20-25% |
| L. Mouthwash | |
| Octanoyl-Arg-Trp-Phe-NH₂ | 0.001-20% |
| triclosan | 0.001-5% |
| sorbitol (70%) | 10% |
| glycerin (99.7%) | 10% |
| ethanol (95%) | 15% |
| propylene glycol | 15% |
| sodium lauryl sulfate | 0.50% |
| Tauranol (97%) (sodium | 0.25% |
| methyl cocoyl taurate) | |
| Pluronic F127 | 0.25% |
| mint flavor | 0.10% |
| water | balance |
| M. Toothpaste | |
| Decanoyl-Arg-NH-decyl | 0.00001-10% |
| triclosan | 0.001-5% |
| sodium monofluorophosphate | 0.19% |
| propylene glycol | 30% |
| glycerin | 10% |
| Zeodent 115 | 20% |
| (silica polishing agent) | |
| sorbitol | 25% |
| Sylodent 15 | 2% |
| (silica thickener) | |
| Pluronic F127 | 0.5% |
| Tauranol | 0.5% |
| Flavor | 1% |
| K₂HPO₄ | 0.5% |
| titanium dioxide | 0.5% |
| iota-carrageenan | 0.3% |
| sodium saccharin | 0.3% |
| sterile deionized water | balance |
| N. Tooth gels | |
| Decanoyl-Arg-Trp-Phe-NH₂ | 0.00001-10% |
| triclosan | 0.001-5% |
| glycerin | 2-50% |
| poloxamer | 10-25% |
| sodium lauryl sulfate | 0.12-12% |
| peppermint oil | 0.1-5% |
| alpha tocopherol | 0.075-8% |
| calcium laurate | 0.025-5% |
| sodium fluoride | 0.02-5% |
| coloring agent | 0.01-5% |
| xylitol (sweetner) | 0.15-20% |
| zinc acetate | 0.015-3% |
| pyrogen-free, sterile deionized water | balance |
| O. Body Washes | |
| Nonanoyl-R-NH-nonyl | 0.001-20% |
| preservative (phenoxyethanol) | 0.0001-10% |
| dimethylsiloxane-methyl siloxane | 0.5-2.5% |
| copolymer | |
| potassium cocoyl hydrolyzed | 5-40% |
| collagen | |
| coconut oil potassium soap (40%) | 0.5-15% |
| coconut oil fatty acid | 1-15% |
| diethanolamide | |
| lauric acid diethanolamide | 1-15% |
| pyrogen-free, sterile deionized water | balance |
| P. Ointment | |
| Octanoyl-Arg-Ala-NH-octyl | 0.00001-20% |
| preservative or antimicrobial | 0.0001-10% |
| tocopherol acetate | 0.05-5% |
| retinol palmitate | 0.1-10% |
| stearyl alcohol | 1-30% |
| Japan wax | 2-40% |
| polyoxyethylene (10) monooleate | 0.025-5% |
| glycerol monostearate | 0.03-10% |
| vaseline | 5-45% |
| pyrogen-free, sterile deionized water | balance |

### Example 11

Examples of cosmetic formulations comprising peptides of the present invention include:

| | |
|---|---|
| A. Liquid Makeup Foundation | |
| Nonanoyl-Arg-Trp-Phe-NH₂ | 0.000001-10% |
| preservative | 0.0001-10% |
| isostearyl neopentanoate | 4-6% |
| isocetyl stearate | 5-10% |
| triisocetyl citrate | 3-6% |
| Generol 122E | 1-3% |
| glyceryl stearate | 1-3% |
| Generol 122 | 0.5-3% |
| dimethicone | 0.5-3% |
| propylparben | 0.5-0.15% |
| cocamido propyl betaine | 0.5-2% |
| disodium oleamido PBG sulfosuccinate | 0.5-1% |
| magnesium aluminum silicate | 0.1-0.5% |
| xanthan gum | 0.1-0.5% |
| propylene glycol | 3-6% |
| glycerin | 1-3% |
| disodium EDTA | 0.05-0.1% |
| imidazolidinyl urea | 0.2-0.3% |
| methylparaben | 0.1-0.3% |
| sodium dehydroacetate | 0.05-0.2% |
| lactic acid | 0-5% |
| pyrogen-free, sterile deionized water | 45-60% |
| iron oxides | 1-3% |
| titanium dioxide | 5-10% |
| sodium hydroxide or citric acid | q.s. to pH 5-5.5 |
| B. Foundation | |
| Octanoyl-Arg-Cys-NH-octyl | 0.001-5 parts |
| preservative | 0.0001-10% |
| mica | 6-60 parts |
| talc | 4-40 parts |
| titanium dioxide | 0.1-3 parts |
| calcium phosphate | 0.5-7 parts |
| brown iron oxide | 0.5-5 parts |
| yellow iron oxide | 0.001-1 part |
| red iron oxide | 0.05-5 parts |
| black iron oxide | 0.05-5 parts |
| C. Creamy Lipstick Formulation | |
| Octanoyl-Arg-Phe-NH-octyl | 0.000001-5% |
| BHT | 0.0001-10% |
| castor oil | 30-40% |
| isopropyl lanolate | 5-15% |
| mica | 4-6% |
| titanium dioxide | 3-6% |
| iron oxides | 0.5-4% |
| FD & C colors | 3-7% |
| isopropyl lanolate | 8-15% |
| Candelilla wax | 7-10% |
| isostearyl neopentanoate | 3-10% |
| beeswax | 0.5-5% |
| microcrystalline wax | 0.5-5% |
| carnauba wax | 0.4-1% |
| propylparaben | 0.05-3% |
| tocopherol | 0.05-0.5% |
| D. Eyeshadow | |
| Octanoyl-Arg-Gly-NH-octyl | 0.0001-5 g |
| preservative | 0.0001-10% |
| talc | 8-100 g |
| aluminum stearate | 0.6-15 g |
| zinc stearate | 0.6-15 g |
| ultramarine blue | 0.5-15 g |
| black iron oxide | 0.01-5 g |
| chromium hydroxide green | 0.2-5 g |
| yellow iron oxide | 0.05-5 g |
| E. Blush | |
| Octanoyl-Arg-His-NH-octyl | 0.0001-5 g |
| preservative | 0.0001-10% |
| sericite | 4-50 g |
| talc | 2-35 g |
| mica | 1-20 g |
| kaolin | 0.5-10 g |
| aluminum stearate | 0.6-15 g |
| red iron oxide | 0.4-10 g |
| black iron oxide | 0.01-2 g |
| brown iron oxide | 0.8-16 g |
| yellow iron oxide | 0.02-5 g |
| titanium dioxide | 0.4-5 g |

### Example 12

Examples of peptide-containing compositions for medical devices include:

A. Polyurethane Adhesive Film Containing Pharmaceutical Composition

| | |
|---|---|
| Octanoyl-Arg-Trp-Cys-NH₂ | 0.025-20% |
| antimicrobial | 0.0001-10% |
| polyoxyethylene glycol | 2-5% |
| polyurethane adhesive solution | 10-25% |

when coated and dried results in a tacky, adhesive film for dressing wounds.

B. Suture Containing Pharmaceutical Composition

| | |
|---|---|
| Octanoyl-His-Arg-NH-octyl | 0.025-20% |
| antimicrobial | 0.0001-10% |
| polyoxyethylene glycol | 2-5% |

suture dipped in solution above and excess wiped away with a paper towel for dressing wounds.

C. Catheter Containing Pharmaceutical Composition

| | |
|---|---|
| Octanoyl-Arg-NH-CH₂-C₆ H₅ | 0.025-20% |
| Antimicrobial | 0.0001-10% |
| polyoxyethylene glycol | 2-5% |

solution above is applied onto the surface of polyurethane catheter

D. Foam Dressing Containing Pharmaceutical Composition

| | |
|---|---|
| Octanoyl-Arg-Arg-Arg-NH-octyl | 0.025-20% |
| antimicrobial | 0.0001-10% |
| polyoxyethylene glycol | 2-5% |

3.5 g of above solution is mixed with 5.5 g polyurethane prepolymer and then 5.5 g water to form a foam which is dried and then sliced to produce foam dressings

Hydrocolloid Dressing Containing Pharmaceutical Composition

| | | |
|---|---|---|
| E. | Nonanoyl-Arg-Arg-NH-nonyl | 0.025-20% |
| | antimicrobial | 0.0001-10% |
| | polyoxyethylene glycol | 2-5% |

2 g of above solution is mixed with 4 g sodium carboxymethyl cellulose and then 4 g polyurethane prepolymer. Mixture is pressed between a polyurethane film and silicone-treated polyester liner to make a 2.5 mm thick treated hydrocolloid matrix which is allowed to cure for 24 hours.

### Example 13

Examples of peptide-containing compositions for use in animal feed include:

| | | |
|---|---|---|
| A. | Octanoyl-Arg-Trp-NH₂ | 0.01-5% |
| | monensin | 0.0001-10% |
| | corn silage | 5-35% |
| | alfalfa silage | 1-30% |
| | alfalfa hay | 1-25% |
| | ground barley | 1-20% |
| | ground corn | 5-15% |
| | soybean meal | 1-65% |
| B. | heptanoyl-Arg-Arg-NH-heptyl | 0.01-5% |
| | monensin | 0.0001-10% |
| | corn silage | 5-35% |
| | alfalfa silage | 1-30% |
| | alfalfa hay | 1-25% |
| | ground barley | 1-20% |
| | ground shelled corn | 5-15% |
| | calcium salts of palm oil | 0.5-5% |
| | dry molasses | 0.5-5% |
| | ammonium phosphate | 0.1-5% |
| | mineral mix (including vitamins A, | 0.5-10% |
| | D, and E; magnesium oxide, selenium, | |
| | magnesium and potassium sulfate) | |

### Example 14

Examples of peptides of the present invention useful as a food preservative against microbes such as Salmonella typhimurium and Clostridium botulinum include:

| PEPTIDES | MIC (μg/ml) |
|---|---|
| Octanoyl-Arg-Ala-NH-octyl | ≦15 |
| Octanoyl-Arg-Cys-NH-octyl | ≦15 |
| Decanoyl-Arg-NH-decyl | ≦8 |
| Octanoyl-Arg-Trp-NH₂ | ≦15 |
| Nonanoyl-Arg-NH-nonyl | ≦4 |
| Octanoyl-Lys-Arg-NH-octyl | ≦4 |
| Acetyl-Arg-Trp-Arg-Trp-NH₂ | ≦31 |

### Example 15

### Peptide Compositions for Textiles

Peptide compositions comprising peptides of the present invention and at least one biocide or germicide may be applied by coating or spinning effective amounts of peptide onto or into the desired polymer. The peptides may be prepared in an aqueous solution to use as a coating solution or combined with a polymer. The coating solutions may contain small water-soluble molecules that do not interfere with the antimicrobial action of the peptide. A peptide and polymer solution or mixture may be made and undergo casting or formation to the desired shaped article, fiber or film. The shaped article, fiber or film may then be quenched in water or methanol, allowed to air dry or dry under an appropriate atmosphere to prevent oxidative reactions.

| | |
|---|---|
| Decanoyl-Arg-Arg-NH-decyl | 0.01-15% |
| Antimicrobial | 0.0001-10% |
| Polymer solution | 10%-15% |
| (e.g., containing wool or cotton) | |

The resulting solution may be placed into a microscale spinning apparatus and fiber is formed while wet with methanol. The antimicrobial activity of the peptides may be tested in tubes containing LB media innoculated with the peptide-containing fiber and E. coli growing at log phase (1×10⁶ to 1×10⁷ cells/ml). Aliquots can be taken from the culture tube at periodic intervals and absorbance readings at 600 nm (uv/vis) can be measured in a microcuvette.

| Peptides | MIC (μg/ml) |
|---|---|
| Octanoyl-Arg-Trp-Phe-NH₂ | ≦15 |
| Octanoyl-Arg-Arg-Arg-NH-octyl | ≦8 |
| Octanoyl-Arg-Phe-Phe-Arg-NH-octyl | ≦4 |
| Decanoyl-Arg-NH-decyl | ≦15 |
| Octanoyl-Arg-Trp-NH₂ | ≦15 |
| Nonanoyl-Arg-Arg-NH-nonyl | ≦2 |
| Acetyl-Arg-Trp-Arg-Trp-NH₂ | ≦31 |

### Example 16

Examples of peptide compositions comprising peptides and at least one antimicrobial and liposomes include:

Composition comprising liposomes and Octanoyl-Arg-Gln-NH-octyl for inhibition of microbial growth in cell culture at 37° C.

| | | |
|---|---|---|
| Octanoyl-Arg-Gln-NH-octyl | 0.5-50 | μg |
| antimicrobial | 0.002-7.8 | μg |
| Liposome (unilamellar or | 2-400 | μg |
| (multilamellar) | | |

Viable cell counts can be performed after 3 hours to show up to a 97% reduction in growth of K. pneumonia and P. aeruginosa as compared to untreated cultures.

Efficacy of peptide composition comprising liposomes, Octanoyl-Arg-Arg-NH-octyl and at least one antimicrobial against several clinically relevant organisms can be determined.

| Organism | | MIC (μg/ml) |
|---|---|---|
| C. albicans | ATCC 10231 | ≦31 |
| B. cepacia | ATCC 25416 | ≦125 |
| E. coli | ATCC 25922 | ≦4 |
| K. pneumoniae | ATCC 10031 | ≦4 |
| P. aeruginosa | ATCC 27853 | ≦2 |
| S. aureus(MRSA) | ATCC 33591 | ≦2 |
| S. aureus | ATCC 29213 | ≦4 |

Effect of combinations of triclosan and sub-toxic levels of peptide on microbial growth is assessed. A peptide of the invention is used in sub-toxic amounts to substantially increase the inhibitory effect of triclosan against microorganisms. Thus, the potential use rate of triclosan as an antimicrobial is shown to be reduced.

### Example 17

K. pneumoniae and P. aeruginosa are grown in the presence of 508, C-3 1, C-41A, C-68, C-74, BT91-W and BT97-W biocide formulations with and without a peptide of the invention. In the presence of peptide, the concentration of biocide to achieve growth on is significantly reduced.

Although the invention has been described with reference to particular means, materials and embodiments, it is to be understood that the invention is not limited to the ars disclosed, and extends to all equivalents within the scope of the claims.

What is claimed is:

1. An antimicrobial composition comprising at least one chemically-modified peptide and a second antimicrobial compound wherein said chemically-modified peptide is represented by Formula I: 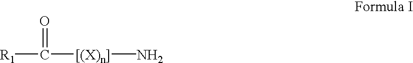
wherein:
X is any natural or non-natural, modified or unmodified amino acid except glutamate or aspartate;
n=1 to 5;
(a) when said chemically-modified peptide is 1-3 amino acids, at least one amino acid is a cationic amino acid, the net charge of said peptide at neutral pH is at least +1, and said chemically-modified peptide does not contain glutamate or aspartate;
(b) when said chemically-modified peptide is 4-5 amino acids, at least two of the amino acids are cationic amino acids, the net charge of said peptide at neutral pH is at least +2, and said chemically-modified peptide does not contain glutamate or aspartate;
wherein:
R₁ is C₁-C₂₀ alkyl; C₃-C₆ cycloalkyl; C₄-C₂₀ alkenyl; C₄-C₂₀ alkynyl; C₁-C₂₀ haloalky; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;
R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;
R₃ is independently hydrogen; C₁-C₄ alkyl; or phenyl optionally substituted with at least one R₈;
R₄ is independently hydrogen; C₁-C₈ alkyl; or phenyl optionally substituted with at least one R₈,
R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;
R₆ is independently methyl; ethyl; methoxy; methylthio; halogen; or trifluoromethyl;
R₇ is independently halogen;
R₈ is independently halogen; C₁-C₄ alkyl; C₁-C₄ alkoxy; C₁-C₄ haloalkyl; nitro; or cyano; and
wherein said second antimicrobial compound is a compound selected from the group consisting of a biocide, a germicide, an antibacterial agent, an antiviral agent, an antifungal agent and an antiparasitic agent.

2. The antimicrobial composition of claim 1 wherein said chemically-modified peptide comprises 2 amino acids, and wherein the N-terminal amino acid is a cationic amino acid and the C-terminal amino acid is any amino acid except glutamate or aspartate.

3. The antimicrobial composition of claim 1 wherein said chemically-modified peptide is selected from the group consisting of Arg-Trp; Lys-Trp; and Orn-Trp.

4. The antimicrobial composition of claim 1 wherein said chemically-modified peptide is selected from the group consisting of Arg-Phe-Arg; Lys-Phe-Arg; Lys-Phe-Lys; Arg-Phe-Lys; Orn-Phe-Arg; Orn-Phe-Orn; Arg-Phe-Orn; Arg-Trp-Phe; Lys-Trp-Phe; Orn-Trp-Phe; Arg-Trp-Cys; Lys-Trp-Cys; Orn-Trp-Cys; Arg-Phe-Trp; Lys-Phe-Trp; Orn-Phe-Trp; Arg-Arg-Trp; Lys-Lys-Trp; Lys-Arg-Trp; Arg-Lys-Trp; Orn-Orn-Trp; Orn-Arg-Trp; Arg-Orn-Trp; Arg-Trp-Arg; Lys-Trp-Arg; Arg-Trp-Lys; Lys-Trp-Lys; Orn-Trp-Arg; Arg-Trp-Orn; and Orn-Trp-Orn.

5. The antimicrobial composition of claim 1 wherein said chemically-modified peptide is selected from the group consisting of SEQ ID NO:1; SEQ ID NO:2; SEQ ID NO:3; SEQ ID NO:4; SEQ ID NO:5; SEQ ID NO:6; SEQ ID NO:7; SEQ ID NO:8; SEQ ID NO:9; SEQ ID NO:10; SEQ ID NO:11; SEQ ID NO:12; SEQ ID NO:13; SEQ ID NO:14; SEQ ID NO:15; SEQ ID NO:16; SEQ ID NO:17; SEQ ID NO:18; SEQ ID NO:19; SEQ ID NO:20; SEQ ID NO:21; SEQ ID NO:22; and SEQ ID NO:23.

6. The composition of claim 1 wherein said second antimicrobial compound comprises a biocide selected from the group consisting of dodecylguanidine hydrochloride; methylene bis(thiocyanate); n-alkyl dimethylbenzylammonium chloride; glutaraldehyde; 2,2-dibromo-3-nitrilo propionamide; 5-chloro-2-methyl-4-isothiazolin-3-one; 2-methyl-4-isothiazolin-3-one; or 2-bromo-2-nitropropane-1,3-diol; sodium or calcium hypochlorite; sodium bromide; β-bromo-β-nitrostyrene; oxazolidines; chromated copper arsenate; zinc pyrithione; copper pyrithione; a carbamate; a halohydantoin; dinonylsulfosuccinate; and sodium lauryl sulfate.

7. The antimicrobial composition of claim 6 wherein said biocide is present in an amount of about 0.0000002% to about 5% by weight of biocide based on the weight percentage of the total composition.

8. The antimicrobial composition of claim 1 wherein said additional antimicrobial compound comprises a germicide selected from the group consisting of 2,4,4′ trichloro-2′-hydroxydiphenylether, 1-(4-chlorophenyl)-3-(3,4-dichlorophenyl) urea, isopropylmethylphenol, chlorhexidine hydrochloride, hexamidine diisethionate, octopirox, chloroxylenol, benzoyl peroxide, phenoxy alcohols, and hydroxybenzoic acids.

9. The antimicrobial composition of claim 8 wherein said germicide is present in an amount of about 0.0001% to about 10% by weight of germicide based on the weight percentage of the total composition.

10. The antimicrobial composition of claim 1 wherein said antibacterial agent is selected from the group consisting of a penicillin, a cephalosporin, a carbapenem, a β-lactamase inhibitor, an aminoglycoside, an aminocyclitol, a quinolone, a macrolide, a tetracycline, a glycopeptide, a lipopeptide, a lincosamide, a streptogramin, a sulfonamide, a trimethoprim, a protein antibiotic other than said peptide, a chloramphenicol, a metronidazole, a rifampin, a fosfomycin, a methenamine, an ethambutol and a pentamidine.

11. The antimicrobial composition of claim 10 wherein said antibacterial agent is present in an amount of about 0.0001% to about 10% by weight of antibiotic based on the weight percentage of the total composition.

12. The antimicrobial composition of claim 1 wherein said antiviral agent is a compound selected from the group consisting of acyclovir, a DNA synthesis inhibitor, a reverse transcriptase inhibitor, a protease inhibitor, IFN-α, and ribavirin.

13. The antimicrobial composition of claim 1 wherein said antifungal agent is a compound selected from the group consisting of a polyene, an imidazole, a triazole, and a glucan synthesis inhibitor.

14. The antimicrobial composition of claim 1 wherein said antiparasitic agent is a compound selected from the group consisting of chloroquine, primaquine, sulfadoxine-pyrimethamine, metronidazole, pentamidine, benzinidazole and praziquantel.

15. The antimicrobial composition of claim 1 further comprising at least one carrier.

16. The antimicrobial composition of claim 15 wherein said carrier is selected from the group consisting of a pharmaceutically acceptable carrier, an industrially acceptable carrier, a household product, and a personal care composition.

17. The antimicrobial composition of claim 16 wherein said pharmaceutically acceptable carrier comprises at least one compound selected from the group consisting of waxes, cellulose derivatives, mineral oils, vegetable oils, petroleum derivatives, water, anhydrous lanolin, white petrolatum, liquid petrolatum, olive oil, ethanol and ethanol-polysorbate 80 solutions, propylene glycol-water solutions, jojoba oils, methylcellulose, paraffin, beeswax, glyceryl stearate, PEG-2 stearate, propylene glycol stearate, glycol stearate, cetyl alcohol, stearyl alcohol, and mixtures thereof.

18. The antimicrobial composition of claim 17 wherein said carrier is present in an amount of about 1% to about 99% by weight of said composition.

19. An antimicrobial composition comprising at least one chemically-modified peptide and a second antimicrobial compound wherein said chemically-modified peptide is represented by Formula II: 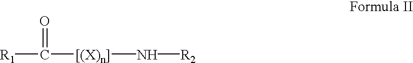
wherein:
X is any natural or non-natural, modified or unmodified amino acid except glutamate or aspartate;
n=1 to 10;
(a) when said chemically-modified peptide is 1-3 amino acids, at least one amino acid is a cationic amino acid, the net charge of said peptide at neutral pH is at least +1, and said chemically-modified peptide does not contain glutamate or aspartate;
(b) when said chemically-modified peptide is 4-5 amino acids, at least two of the amino acids are cationic amino acids, the net charge of said peptide at neutral pH is at least +2, and said chemically-modified peptide does not contain glutamate or aspartate;
(c) when said chemically-modified peptide is 6-8 amino acids, at least three of the amino acids are cationic amino acids, the net charge of the peptide at neutral pH is preferably at least +3, and said chemically-modified peptide does not contain glutamate or aspartate; and
(d) when said chemically-modified peptide is 9-10 amino acids, at least four of the amino acids are cationic amino acids, the net charge of the peptide at neutral pH is preferably at least +4, and said chemically-modified peptide does not contain glutamate or aspartate;
wherein:
R₁ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁- C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;
R₂ is C₁-C₂₀ alkyl; C₃-C₆ cycloalkyl; C₄-C₂₀ alkenyl; C₄-C₂₀ alkynyl; C₁-C₂₀ haloalkyl; C₃-C₂₀ haloalkenyl; C₃-C₂₀ haloalkynyl; C₂-C₂₀ alkoxyalkyl; C₂-C₂₀ alkylthioalkyl; C₂-C₂₀ alkylsulfinylalkyl; C₂-C₂₀ alkylsulfonylalkyl; C₅-C₂₀ cycloalkylalkyl; C₄-C₂₀ alkenyloxyalkyl; C₄-C₂₀ alkynyloxyalkyl; C₄-C₂₀ (cycloalkyl) oxyalkyl; C₄-C₂₀ alkenylthioalkyl; C₄-C₂₀ alkynylthioalkyl; C₆-C₂₀ (cycloalkyl) thioalkyl; C₂-C₂₀ haloalkoxyalkyl; C₄-C₂₀ haloalkenyloxyalkyl; C₄-C₂₀ haloalkynyloxyalkyl; C₄-C₂₀ alkoxylalkenyl; C₄-C₂₀ alkoxyalkynyl; C₄-C₂₀ alkylthioalkenyl; C₄-C₂₀ alkylthioalkynyl; C₄-C₂₀ trialkylsilylalkyl; C₁-C₂₀ alkyl substituted with NR₃R₄, nitro, cyano, or phenyl optionally substituted with R₅, R₆, and R₇; C₁-C₂₀ alkoxy; C₁-C₂₀ haloalkoxy; C₁-C₂₀ alkylthio; C₁-C₂₀ haloalkylthio; NR₃R₄; or phenyl, benzyl, pyridyl, furanyl, thienyl, naphthyl, pyrimidinyl, benzofuranyl, benzothienyl, or quinolinyl each optionally substituted with R₅, R₆ or R₇;
R₃ is independently hydrogen; C₁-C₄ alkyl; or phenyl optionally substituted with at least one R₈;
R₄ is independently hydrogen; C₁-C₈ alkyl; or phenyl optionally substituted with at least one R₈;
R₅ is independently C₁-C₆ alkyl; C₁-C₆ alkoxy; C₁-C₆ haloalkyl; halogen; C₂-C₈ alkynyl; C₁-C₆ thioalkyl; phenyl or phenoxy each optionally substituted with at least one R₈; cyano; nitro; C₁-C₆ haloalkoxy; C₁-C₆ haloalkythio; C₂-C₆ alkenyl; C₂-C₆ haloalkenyl; acetyl; CO₂CH₃; or N(C₁-C₂ alkyl)₂;
R₆ is independently methyl; ethyl; methoxy; methylthio; halogen; or trifluoromethyl;
R₇ is independently halogen;
R₈ is independently halogen; C₁-C₄ alkyl; C₁-C₄ alkoxy; C₁-C₄ haloalkyl; nitro; or cyano; and
wherein:
said second antimicrobial compound is a compound selected from the group consisting of a biocide, a biodispersant, a germicide, a preservative, an antibacterial agent, an antiviral agent, an antifungal agent and an antiparasitic agent.

20. The antimicrobial composition of claim 19 wherein said chemically-modified peptide is selected from the group consisting of arginine, lysine and ornithine.

21. The antimicrobial composition of claim 19 wherein said chemically-modified peptide comprises 2 amino acids wherein at least one of the amino acids is a cationic amino acid, wherein the net charge of said peptide is at least +1.

22. The antimicrobial composition of claim 19 wherein said chemically-modified peptide is selected from the group consisting of Arg-Arg; Arg-Phe; Arg-Tyr; Arg-Ala; Arg-Ile; Arg-Leu; Arg-Pro; Arg-Val; Arg-Cys; Arg-Met; Arg-Ser; Arg-Thr; Arg-Asn; Arg-Gln; Arg-Nal; Arg-His; Arg-Gly; Phe-Arg; Tyr-Arg; Ala-Arg; Ile-Arg; Leu-Arg; Pro-Arg; Val-Arg; Cys-Arg; Met-Arg; Ser-Arg; Thr-Arg; Asn-Arg; Gln-Arg; Nal-Arg; His-Arg; and Gly-Arg.

23. The antimicrobial composition of claim 19 wherein said chemically-modified peptide is selected from the group consisting of Arg-Arg-Arg; Arg-Phe-Arg; Arg-Tyr-Arg; Arg-Ala-Arg; Arg-Ile-Arg; Arg-Leu-Arg; Arg-Pro-Arg; Arg-Val-Arg; Arg-Cys-Arg; Arg-Met-Arg; Arg-Ser-Arg; Arg-Thr-Arg; Arg-Asn-Arg; Arg-Gln-Arg; Arg-Nal-Arg; Arg-Orn-Arg; Arg-His-Arg; Arg-Lys-Arg; Arg-Gly-Arg; Arg-Arg-Nal; Arg-Arg-Phe; Arg-Arg-Tyr; Arg-Arg-Ala; Arg-Arg-Ile; Arg-Arg-Leu; Arg-Arg-Pro; Arg-Arg-Val; Arg-Arg-Cys; Arg-Arg-Met; Arg-Arg-Ser; Arg-Arg-Thr; Arg-Arg-Asn; Arg-Arg-Gln; Arg-Arg-Lys; Arg-Arg-His; Arg-Arg-Orn; and Arg-Arg-Gly.

24. The antimicrobial composition of claim 19 wherein said second antimicrobial compound comprises a biocide selected from the group consisting of dodecylguanidine hydrochloride; methylene bis(thiocyanate); n-alkyl dimethylbenzylammonium chloride; glutaraldehyde; 2,2-dibromo-3-nitrilo propionamide; 5-chloro-2-methyl-4-isothiazolin-3-one; 2-methyl-4-isothiazolin-3-one; or 2-bromo-2-nitropropane-1,3-diol; sodium or calcium hypochlorite; sodium bromide; β-bromo-β-nitrostyrene; oxazolidines; chromated copper arsenate; zinc pyrithione; copper pyrithione; a carbamate; a halohydantoin; dinonylsulfosuccinate; and sodium lauryl sulfate.

25. The antimicrobial composition of claim 24 wherein said biocide is present in an amount of about 0.0000002% to about 5% by weight of biocide based on the weight percentage of the total composition.

26. The antimicrobial composition of claim 19 wherein said second antimicrobial compound comprises a germicide selected from the group consisting of 2,4,4′ trichloro-2′-hydroxydiphenylether, 1-(4-chlorophenyl)-3-(3,4-dichlorophenyl) urea, isopropylmethylphenol, chlorhexidine hydrochloride, hexamidine diisethionate, octopirox, chloroxylenol, benzoyl peroxide, phenoxy alcohols, and hydroxybenzoic acids.

27. The antimicrobial composition of claim 26 wherein said germicide is present in an amount of about 0.0001% to about 10% by weight of germicide based on the weight percentage of the total composition.

28. The antimicrobial composition of claim 19 wherein said antibacterial agent is selected from the group consisting of a penicillin, a cephalosporin, a carbapenem, a β-lactamase inhibitor, an aminoglycoside, an aminocyclitol, a quinolone, a macrolide, a tetracycline, a glycopeptide, a lipopeptide, a lincosamide, a streptogramin, a sulfonamide, a trimethoprim, a protein antibiotic other than said peptide, a chloramphenicol, a metronidazole, a rifampin, a fosfomycin, a methenamine, an ethambutol and a pentamidine.

29. The antimicrobial composition of claim 28 wherein said antibacterial agent is present in an amount of about 0.0001% to about 10% by weight of antibiotic based on the weight percentage of the total composition.

30. The antimicrobial composition of claim 19 wherein said antiviral agent is a compound selected from the group consisting of acyclovir, a DNA synthesis inhibitor, a reverse transcriptase inhibitor, a protease inhibitor, IFN-α, and ribavirin.

31. The antimicrobial composition of claim 19 wherein said antifungal agent is a compound selected from the group consisting of a polyene, an imidazole, a triazole, and a glucan synthesis inhibitor.

32. The antimicrobial composition of claim 19 wherein said antiparasitic agent is a compound selected from the group consisting of chloroquine, primaquine, sulfadoxine-pyrimethamine, metronidazole, pentamidine, benzinidazole and praziquantel.

33. The antimicrobial composition of claim 19 further comprising at least one carrier.

34. The antimicrobial composition of claim 33 wherein said carrier is selected from the group consisting of a pharmaceutically acceptable carrier, an industrially acceptable carrier, a household product, and a personal care composition.

35. The antimicrobial composition of claim 34 wherein said pharmaceutically acceptable carrier comprises at least one compound selected from the group consisting of waxes, cellulose derivatives, mineral oils, vegetable oils, petroleum derivatives, water, anhydrous lanolin, white petrolatum, liquid petrolatum, olive oil, ethanol and ethanol-polysorbate 80 solutions, propylene glycol-water solutions, jojoba oils, methylcellulose, paraffin, beeswax, glyceryl stearate, PEG-2 stearate, propylene glycol stearate, glycol stearate, cetyl alcohol, stearyl alcohol, and mixtures thereof.

36. The antimicrobial composition of claim 35 wherein said carrier is present in an amount of about 1% to about 99% by weight of said composition.

37. A method of preventing, inhibiting, or terminating the growth of at least one microbe comprising administering an antimicrobial amount of a composition of claims 1 or 19.


SEQUENCE LISTING (28 sequences)

SEQ ID NO: 1 - protein, 4 aa, Artificial Sequence
  synthetic peptide
RWFR

SEQ ID NO: 2 - protein, 4 aa, Artificial Sequence
  synthetic peptide
RWRF

SEQ ID NO: 3 - protein, 4 aa, Artificial Sequence
  synthetic peptide
RWWR

SEQ ID NO: 4 - protein, 4 aa, Artificial Sequence
  synthetic peptide
RRWF

SEQ ID NO: 5 - protein, 4 aa, Artificial Sequence
  synthetic peptide
RWRW

SEQ ID NO: 6 - protein, 4 aa, Artificial Sequence
  synthetic peptide
RFRW

SEQ ID NO: 7 - protein, 4 aa, Artificial Sequence
  synthetic peptide
RRFW

SEQ ID NO: 8 - protein, 4 aa, Artificial Sequence
  synthetic peptide
RWAR

SEQ ID NO: 9 - protein, 4 aa, Artificial Sequence
  synthetic peptide
RWYR

SEQ ID NO: 10 - protein, 4 aa, Artificial Sequence
  synthetic peptide
RWIR

SEQ ID NO: 11 - protein, 4 aa, Artificial Sequence
  synthetic peptide
RWLR

SEQ ID NO: 12 - protein, 4 aa, Artificial Sequence
  synthetic peptide
RWPR

SEQ ID NO: 13 - protein, 4 aa, Artificial Sequence
  synthetic peptide
RWVR

SEQ ID NO: 14 - protein, 4 aa, Artificial Sequence
  synthetic peptide
RWCR

SEQ ID NO: 15 - protein, 4 aa, Artificial Sequence
  synthetic peptide
RWMR

SEQ ID NO: 16 - protein, 4 aa, Artificial Sequence
  synthetic peptide
RWSR

SEQ ID NO: 17 - protein, 4 aa, Artificial Sequence
  synthetic peptide
RWTR

SEQ ID NO: 18 - protein, 4 aa, Artificial Sequence
  synthetic peptide
RWNR

SEQ ID NO: 19 - protein, 4 aa, Artificial Sequence
  synthetic peptide
RWQR

SEQ ID NO: 20 - protein, 4 aa, Artificial Sequence
  synthetic peptide
RWXR

SEQ ID NO: 21 - protein, 4 aa, Artificial Sequence
  synthetic peptide
RWHR

SEQ ID NO: 22 - protein, 4 aa, Artificial Sequence
  synthetic peptide
RWKR

SEQ ID NO: 23 - protein, 4 aa, Artificial Sequence
  synthetic peptide
RWGR

SEQ ID NO: 24 - protein, 6 aa, Artificial Sequence
  synthetic peptide
FRWWHX

SEQ ID NO: 25 - protein, 6 aa, Artificial Sequence
  synthetic peptide
RRWWMX

SEQ ID NO: 26 - protein, 6 aa, Artificial Sequence
  synthetic peptide
RRWWCX

SEQ ID NO: 27 - protein, 6 aa, Artificial Sequence
  synthetic peptide
RRWWRX

SEQ ID NO: 28 - protein, 7 aa, Artificial Sequence
  synthetic peptide
RRWWCXX